(19) United States
(12) Patent Application Publication
(10) Pub. No.: US 2026/0291578 A1
(43) Pub. Date: Sep. 24, 2026

(54) CSI FEEDBACK FORMAT FOR AIML-ENABLED CSI COMPRESSION SCHEME

(71) Applicant: Nokia Technologies Oy, Espoo (FI)

(72) Inventors: Jee Hyun KIM, Munich (DE); Keeth Saliya Jayasinghe LADDU, Espoo (FI); Filippo TOSATO, Massy (FR)

(21) Appl. No.: 19/475,309

(22) PCT Filed: Apr. 23, 2024
(86) PCT No.: PCT/IB2024/053947

§ 371 Date: Oct. 14, 2025

Related U.S. Application Data
(60) Provisional application No. 63/464,241, filed on May 5, 2023.

(51) Int. Cl. H04B 7/06

(52) U.S. Cl. CPC H04B 7/0626

(57) ABSTRACT

A UE reports a capability to a network entity indicating supported quantization type(s) for feedback of CSI. The UE receives configuration from the network entity, including information enabling of ML-enabled compression for the CSI and corresponds to the supported quantization type(s). The UE reports the feedback of the CSI to the network entity using a format for PMI designed for the ML-enabled compression, wherein the feedback includes first part and a second part, wherein the first part includes partial or full description of a format of the second part and information indicating size of the second part. A network entity transmits the configuration to the UE and receives the feedback.

### RELATED APPLICATION

This application claims priority to U.S. provisional Application No. 63/464,241 filed May 5, 2023, which is incorporated herein by reference in its entirety.

### TECHNICAL FIELD

Examples of embodiments herein relate generally to wireless communication systems and, more specifically, relate to sending feedback information such as Channel State Information (CSI) when using Artificial Intelligence and Machine Learning (AIML) compression for the same.

### BACKGROUND

In wireless communications systems such as cellular systems, User Equipment (UE), which are wireless, typically mobile devices that connect to the wireless network, feed back certain information to the network. One such feedback information is Channel State Information (CSI), which is an estimate of channel properties between the network (e.g., transmission by a base station or other network element) and the UE. CSI is typically compressed to save bandwidth for transmission from the UE to the network. Previously, this CSI had a known format such that compression and decompression for CSI were known.

Recently, Artificial Intelligence and Machine Learning (AIML) has been implemented for the UE and for the network. Since it is unlikely the vendors of the UE or network elements (such as gNB) would share the internal workings of their AIML devices, this means the CSI feedback format may need modification.

### BRIEF SUMMARY

This section is intended to include examples and is not intended to be limiting.

In an exemplary embodiment, a method is disclosed that includes reporting, at a user equipment, a capability to a network entity, wherein the capability comprises one or more supported quantization types for feedback of channel state information; receiving, at the user equipment, configuration from the network entity, wherein the configuration comprises at least information enabling of machine-learning-enabled compression for the channel state information and corresponds to the one or more supported quantization types; and reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: reporting, at a user equipment, a capability to a network entity, wherein the capability comprises one or more supported quantization types for feedback of channel state information; receiving, at the user equipment, configuration from the network entity, wherein the configuration comprises at least information enabling of machine-learning-enabled compression for the channel state information and corresponds to the one or more supported quantization types; and reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

An exemplary computer program product includes a computer-readable storage medium bearing instructions that, when executed by an apparatus, cause the apparatus to perform at least the following: reporting, at a user equipment, a capability to a network entity, wherein the capability comprises one or more supported quantization types for feedback of channel state information; receiving, at the user equipment, configuration from the network entity, wherein the configuration comprises at least information enabling of machine-learning-enabled compression for the channel state information and corresponds to the one or more supported quantization types; and reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

In another exemplary embodiment, an apparatus comprises means for performing: reporting, at a user equipment, a capability to a network entity, wherein the capability comprises one or more supported quantization types for feedback of channel state information; receiving, at the user equipment, configuration from the network entity, wherein the configuration comprises at least information enabling of machine-learning-enabled compression for the channel state information and corresponds to the one or more supported quantization types; and reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

In an exemplary embodiment, a method is disclosed that includes receiving, at a network entity, indication of capability from a user equipment, wherein the capability comprises one or more supported quantization types for feedback of channel information by the user equipment; transmitting configuration to the user equipment, wherein the configuration comprises at least information enabling of machine-learning-empowered compression for the channel information; and receiving by the network entity the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, at a network entity, indication of capability from a user equipment, wherein the capability comprises one or more supported quantization types for feedback of channel information by the user equipment; transmitting configuration to the user equipment, wherein the configuration comprises at least information enabling of machine-learning-empowered compression for the channel information; and receiving by the network entity the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

An exemplary computer program product includes a computer-readable storage medium bearing instructions that, when executed by an apparatus, cause the apparatus to perform at least the following: receiving, at a network entity, indication of capability from a user equipment, wherein the capability comprises one or more supported quantization types for feedback of channel information by the user equipment; transmitting configuration to the user equipment, wherein the configuration comprises at least information enabling of machine-learning-empowered compression for the channel information; and receiving by the network entity the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

In another exemplary embodiment, an apparatus comprises means for performing: receiving, at a network entity, indication of capability from a user equipment, wherein the capability comprises one or more supported quantization types for feedback of channel information by the user equipment; transmitting configuration to the user equipment, wherein the configuration comprises at least information enabling of machine-learning-empowered compression for the channel information; and receiving by the network entity the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

### BRIEF DESCRIPTION OF THE DRAWINGS

In the attached drawings:

FIG. 1A is a block diagram of one possible and non-limiting exemplary system in which the exemplary embodiments may be practiced;

FIG. 1B is an example of a block diagram of an apparatus suitable for implementing any of the nodes in FIG. 1A;

FIG. 2 is a high-level block diagram of AIML (autoencoder) supported CSI feedback scheme;

FIG. 3 illustrates UE-first separate training operation phases;

FIG. 4 illustrates NW-first separate training operation phases;

FIG. 5 illustrates possible quantization types and focus areas of the examples herein;

FIG. 6 illustrates AIML-enabled CSI feedback format with a legacy split into CSI Part 1 and CSI Part 2;

FIG. 7 illustrates an example of a message sequence chart between UE and gNB regarding AIML-enabled CSI reporting;

FIG. 8 is Table 1, a SQ case without channel eigenvalues, and indicates a maximum number of elements which can be packed in the given payload;

FIG. 9 is Table 2, a SQ case with channel eigenvalues, and indicates maximum number of elements which can be packed in the given payload;

FIG. 10 is Table 3, a VQ case without channel eigenvalues, and indicates a maximum number of subvectors which can be packed in the given payload;

FIG. 11 is Table 4, a VQ case with channel eigenvalues, and indicates a maximum number of subvectors which can be packed in the given payload;

FIG. 12 illustrates a PMI feedback mapping structure proposal for AIML supported CSI compression (SQ case example, channel eigenvector only);

FIG. 13 illustrates a PMI feedback mapping structure proposal for AIML supported CSI compression (SQ case example, channel eigenvectors with channel eigenvalues);

FIG. 14 illustrates a PMI feedback mapping structure proposal for AIML supported CSI compression (VQ case example, channel eigenvector only);

FIG. 15 illustrates a PMI decoding flow example;

FIG. 16 illustrates alternative PMI feedback mapping structure example (SQ case example; channel eigenvector only with identical bit resolution); and

FIG. 17 illustrates an example use case of rank-wise eigenvector AI encoding.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

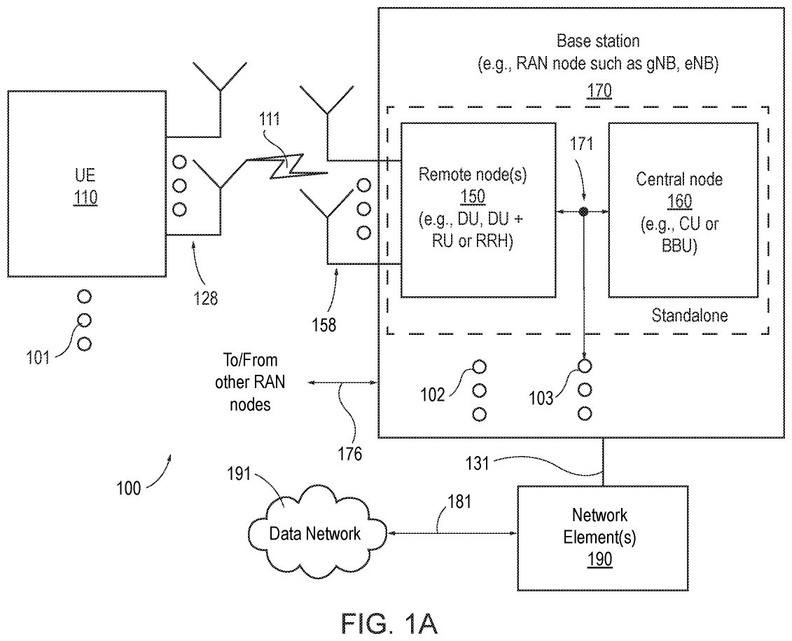

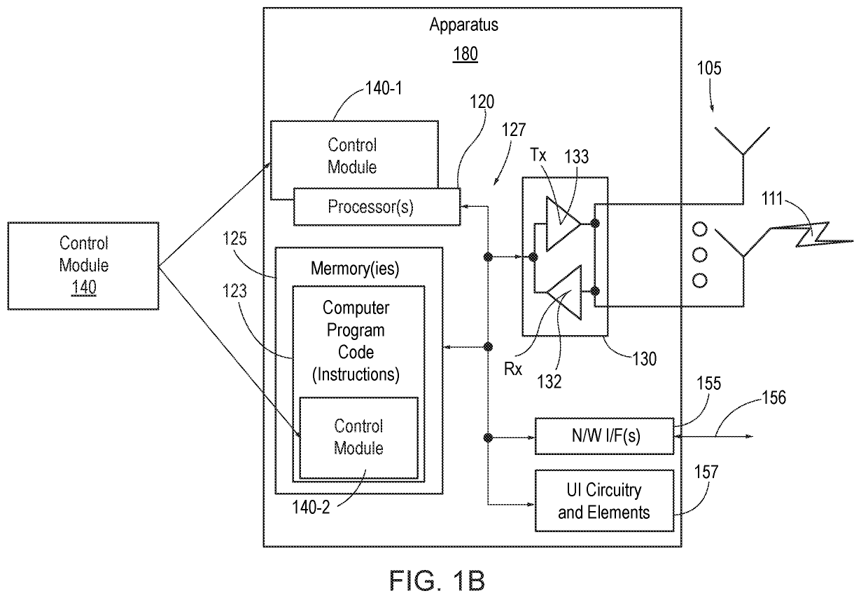

Any flow diagram or signaling diagram herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIGS. 1A and 1B) also illustrate the operation of an exemplary method, results of execution of computer program instructions embodied on a computer readable memory, functions performed by logic implemented in hardware, and/or interconnected means for performing functions in accordance with an exemplary embodiment.

The exemplary embodiments herein describe techniques for CSI feedback format for AIML-enabled CSI compression scheme. Additional description of these techniques is presented after a system into which the exemplary embodiments may be used is described.

Turning to FIG. 1A, this figure shows a block diagram of one possible and non-limiting exemplary system in which the exemplary embodiments may be practiced. A number of nodes are shown: a user equipment (UE) 110; a base station 170; and network element(s) 190.

In FIG. 1A, a user equipment (UE) 110, as one of the nodes, is in wireless communication via wireless link 111 with a wireless network 100. A UE 110 is a wireless, typically mobile device that can access a wireless network. The UE 110 is illustrated with one or more antennas 128. The ellipses 101 indicate there could be multiple UEs 110.

The base station 170, as another of the nodes but one that is part of the wireless network 100, provides access by wireless devices such as the UE 110 to the wireless network 100. The base station 170 is illustrated as having one or more antennas 158. There are many options for the base station 170. In general, the base station 170 is a RAN node, and in particular could be a gNB, which is the primary term used herein. That is, the base station 170 will be referred to as gNB 170. There are, however, many options including an eNB for the base station, or options other than cellular systems.

There are a number of configurations for the base station 170. One such is a “standalone” configuration, which includes all circuitry as part of a single unit, and accesses the antennas 158. More commonly today, circuitry is split into one or more remote nodes 150 (accessing antennas 158) and central nodes 160. For instance, for 5G (also referred to as NR), a gNB might include a distributed unit (DU), or DU and radio unit (RU) as the remote nodes(s), and a central unit (CU) as the central node 160. For LTE, the base station 170 might include an eNB having a remote radio head as remote node 150 and a base band unit (BBU) as a central node 160. The remote node(s) 150 are coupled to a central node 160 via one or more links 171. There could be multiple remote nodes 150 for a single central node 160, and this is indicated by ellipses 102, indicating multiple remote nodes, and ellipses 103, indicating additional links 171. The remote nodes 150 are remote in the sense they are contained in different physical enclosures from a physical enclosure containing a corresponding central node 160. The link(s) 171 may be implemented using fiber optics, wireless techniques, or any other technique for data communications.

Two or more base stations 170 communicate using, e.g., link(s) 176. The link(s) 176 may be wired or wireless or both and may implement, e.g., an Xn interface for 5G, an X2 interface for LTE, or other suitable interface for other standards.

The wireless network 100 may include a network element or elements 190, as a third illustrated node, that may include core network functionality, and which provide connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity) functionality and/or SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards.

In general, the various embodiments of the user equipment 110 can include, but are not limited to, cellular telephones (such as smart phones, mobile phones, cellular phones, voice over Internet Protocol (IP) (VoIP) phones, and/or wireless local loop phones), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 110 could be any end device that may be capable of wireless communication. By way of example rather than limitation, the UE may also be referred to as a communication device, terminal device (MT), a Subscriber Station (SS), a Portable Subscriber Station, a Mobile Station (MS), or an Access Terminal (AT).

Turning to FIG. 1B, this figure is an example of a block diagram of an apparatus 180 suitable for implementing any of the nodes in FIG. 1A. The apparatus 180 includes circuitry comprising one or more processors 120, one or more memories 125, one or more transceivers 130, one or more network (N/W) interface(s) (I/F(s)) 155 and user interface (UI) circuitry and elements 157, interconnected through one or more buses 127. Since this is an example covering all of the nodes in FIG. 1A, some of the nodes may not have all of the circuitry. For example, a base station 170 might not have UI circuitry and elements 157. All of the nodes may have additional circuitry, not described here. FIG. 1B is presented merely as an example.

Each of the one or more transceivers 130 includes a receiver, Rx, 132 and a transmitter, Tx, 133. The one or more buses 127 may be address, data, and/or control buses, and may include any interconnection mechanism, such as a series of lines on a motherboard or integrated circuit, fiber optics or other optical communication equipment, and the like. The one or more transceivers 130 are connected to one or more antennas 105, which could be one of the antennas 128 (from UE 110) or antennas 158 (from base station 170), and may communicate using wireless link 111.

The one or more memories 125 include computer program code 123. The apparatus 180 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code (having corresponding instructions) 123 and is executed by the one or more processors 120. For instance, the one or more memories 125 store instructions that, when executed by the one or more processors 120, cause the apparatus 180 to perform one or more of the operations as described herein. Furthermore, the one or more processors 120, one or more memories 125, and example algorithms (e.g., as flowcharts and/or signaling diagrams), encoded as instructions, programs, or code, are means for causing performance of the operations described herein.

The network interface(s) (N/W I/F(s)) 155 are wired interfaces communicating using link(s) 156, which could be fiber optic or other wired interfaces. The link(s) 156 could be the link(s) 131 and/or 176 from FIG. 1A. The link(s) 131 and/or 176 from FIG. 1A could also be implements using transceiver(s) 130 and corresponding wireless link(s) 111. The apparatus could include only wireless transceiver(s) 130, only N/W I/Fs 155, or both wireless transceiver(s) 130 and N/W I/Fs 155.

The apparatus 180 may or may not include UI circuitry and elements 157. These could include a display such as a touchscreen, speakers, or interface elements such as for headsets. For instance, a UE 110 of a smartphone would typically include at least a touchscreen and speakers. The UI circuitry and elements 157 may also include circuitry to communicate with external UI elements (not shown) such as displays, keyboards, mice, headsets, and the like.

The computer readable memories 125 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 125 may be means for performing storage functions. The processors 120 may be of any type suitable to the local technical environment, and may include one or more of general-purpose computers, special purpose computers, microprocessors, digital signal processors (DSPs) and processors based on a multi-core processor architecture, as non-limiting examples. The processors 120 may be means for performing functions, such as controlling the apparatus 180, and other functions as described herein.

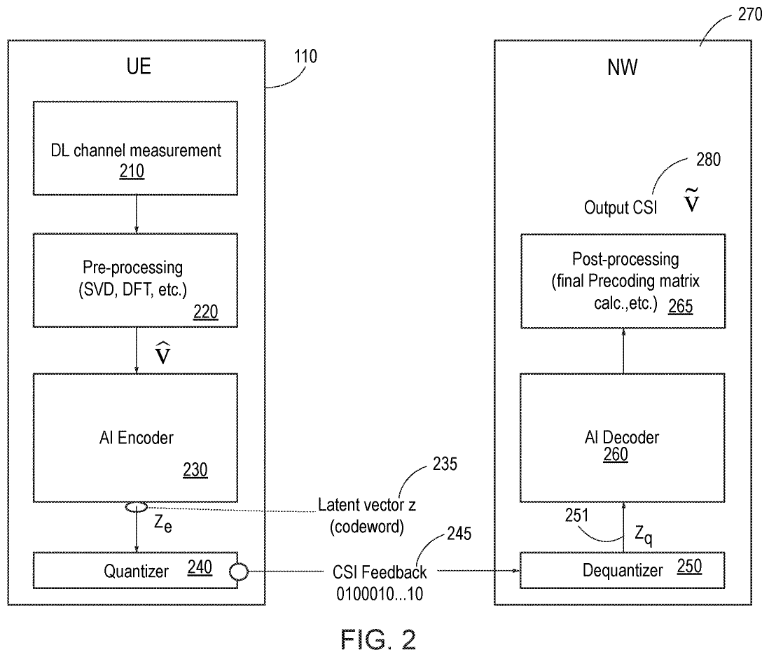

Having thus introduced one suitable but non-limiting technical context for the practice of the exemplary embodiments, the exemplary embodiments will now be described with greater specificity.
3GPP Release 18 has study items in AIML for air interface enhancements. One of the study items of 3GPP Rel-18 is AIML for CSI feedback enhancements. This activity investigates a set up in which a CSI feedback processing part at the UE-side is replaced with an AI encoder (possibly followed by a quantizer), and its output is used as the CSI feedback information to be signaled to the NW over the air. The format of this AI encoded CSI feedback does not necessarily follow the current 3GPP defined format, e.g., Type I, Type II, enhanced Type II codebook, or the like. See FIG. 2, which is a high-level block diagram of AIML (autoencoder) supported CSI feedback scheme. The UE 110 and network 270 (e.g., a network element in the wireless network 100 such as a gNB 170) are shown. The UE 110 performs DL channel measurement 210, then performs pre-processing (e.g., using SVD, DFT, and the like) 220, the output of which is operated on by an AI encoder 230, which produces a latent vector z (e.g., a codeword shown as zₑ) 235, which is quantized by quantizer 240. This process outputs CSI feedback 245, which is dequantized by the dequantizer 250, which produces a dequantized latent vector z_{q} 251, which is operated on by an AI decoder 260. The AI decoder 260 produces an output that is post-processed by post-processing (e.g., final precoding matrix calculation and the like) 265, to determine the output CSI V, which is an estimated channel eigenvector, that is, a “target CSI” in the depicted example.

In more detail, a general AIML (autoencoder)-enabled CSI feedback scheme is depicted in FIG. 2. At the UE side, a downlink channel is estimated (in DL channel measurement 210) using CSI-RS, and any required preprocessing is performed in block 220 on the channel estimates, e.g., SVD to acquire channel eigenvector(s). These channel eigenvectors (see RAN1 #112, Option 1a; see RAN1 agreements box below and R1-2302256, Final Report of 3GPP TSG RAN WG1 #112 v1.0.0) are being fed into the AI encoder 230. The output of the AI encoder 230, i.e., a latent vector, is to be quantized to save CSI (in this case AI-compressed PMI) feedback overhead. At the NW side, the reverse operations, i.e., dequantization 250, AI decoding 260, is performed to reconstruct the original channel information, in this case the channel eigenvector(s). The reconstructed channel information is termed as “output CSI” at 3GPP.

For a typical autoencoder, the AI encoder and AI decoder are trained at the same training session by the same training entity to determine the best possible parameters at the AI encoder and AI decoder (see RAN1 #110, “Type 1: Joint training with single training entity”, R1-2208321, Final Report of 3GPP TSG RAN WG1 #110 v1.0.0). However, this enforces disclosure of the proprietary AI encoder or AI decoder details (AIML framework, architecture, layer configuration, or the like), so it is not so likely that UE and NW vendors would agree on this training option (Type 1). In this sense, “Type 3: Separate training” has been gaining support from numerous UE and NW vendors at 3GPP, as UE vendor and NW vendor do not need to reveal their proprietary AI encoder/decoder related information to other parties.

Separate training can be categorized into two parts, i.e., UE-first training and NW-first training. This can result in output-CSI-UE and input-CSI-NW, the use of which is described now.

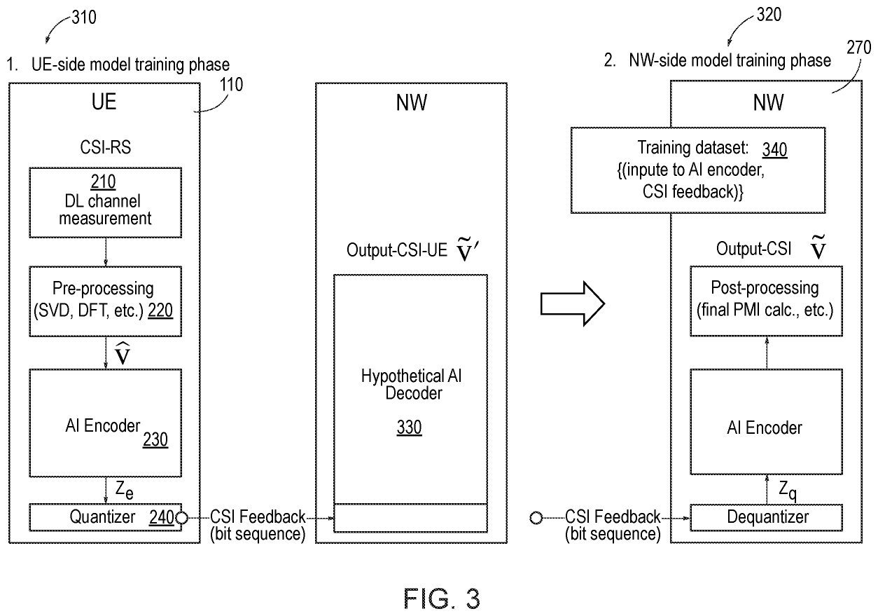

A separate training case does not mandate that UE vendors and NW vendors should share the AIML model details. In case of UE-first training, in which the AI encoder at the UE side is trained first, a UE vendor needs to assume an AI decoder model at the NW side when its UE side AI encoder is being trained together with the corresponding hypothetical AI decoder 330 (phase 1, 310, in FIG. 3). At this UE-side model training phase (phase 1 310), the output at the hypothetical AI decoder of NW side (which is assumed at UE side) is termed as “output-CSI-UE” in 3GPP. There is also a NW-side model training phase 320, where the training data set 340 is used for training, which set includes input to the AI encoder and corresponding CSI feedback.

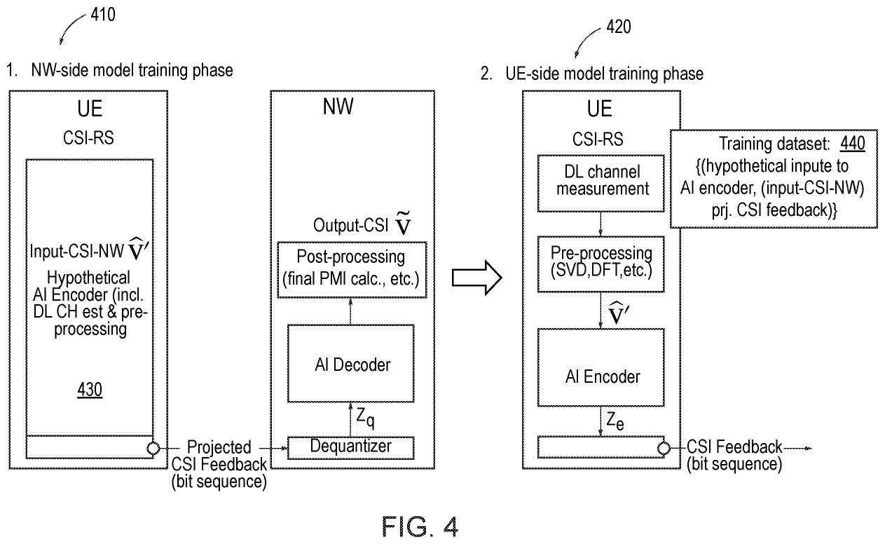

In case of NW-first training, in which the AI decoder at the NW side is trained first, the NW vendor needs to assume an AI encoder model 430 (see FIG. 4) at the UE side when its NW side AI decoder is being trained together with the corresponding hypothetical AI encoder (phase 1 410 in FIG. 4). At this NW-side model training phase (phase 1 410), the input at the hypothetical AI encoder of UE side (which is assumed at NW side) is termed as “input-CSI-NW” in 3GPP. The UE is trained secondly, see reference 420, using the training dataset 440 of hypothetical input to the AI encoder, including input CSI from the NW and projected CSI feedback.

So far, the following relevant agreements were achieved in RAN1:

RAN1#110 Agreement:
In CSI compression using two-sided model use case, the following AI/ML model training
collaborations will be further studied:

| | |
|---|---|
| • | Type 1: Joint training of the two-sided model at a single side/entity, e.g., UE- |
| | sided or Network-sided. |
| • | Type 2: Joint training of the two-sided model at network side and UE side, |
| | respectively. |
| • | Type 3: Separate training at network side and UE side, where the UE-side CSI |
| | generation part and the network-side CSI reconstruction part are trained by UE |
| | side and network side, respectively. |

Note: Joint training means the generation model and reconstruction model should be
trained in the same loop for forward propagation and backward propagation. Joint
training could be done both at single node or across multiple nodes (e.g., through gradient
exchange between nodes).
Note: Separate training includes sequential training starting with UE side training, or
sequential training starting with NW side training [, or parallel training] at UE and NW
Other collaboration types are not excluded.
RAN1#110-e Agreement:
In CSI compression using two-sided model use case, further study potential specification
impact on CSI report, including at least

| | |
|---|---|
| • | CSI generation model output and/or CSI reconstruction model input, including |
| | configuration(size/format) and/or potential post/pre-processing of CSI |
| | generation model output/CSI reconstruction model input. |
| • | CQI determination |
| • | RI determination |

RAN1#112 Agreement:
In CSI compression using two-sided model use case, further study potential specification
impact of the following output-CSI-UE* and input-CSI-NW** at least for Option 1:

| | |
|---|---|
| • | Option 1: Precoding matrix |
| | ∘ 1a: The precoding matrix in spatial-frequency domain |
| | ∘ 1b: The precoding matrix in angular-delay domain |
| • | Option 2: Explicit channel matrix (i.e., full Tx * Rx MIMO channel) |
| | ∘ 2a: raw channel is in spatial-frequency domain |
| | ∘ 2b: raw channel is in angular-delay domain |
| • | Note: Option 1 is prioritized in R18 SI. Further down-selections are not precluded |
| • | Note: RI and CQI will be discussed separately |

In CSI compression using two-sided model use case, at least when output-CSI-UE* type
is precoding matrix, the CSI feedback is composed into two parts:

| | |
|---|---|
| • | Part 1: CQI, RI and other information indicating the size of CSI Part 2. The size |
| | of CSI Part 1 is fixed |
| • | Part 2: The CSI generation model output |

In CSI compression using two-sided model use case, further study at least the following
potential specification impact on quantization alignment including:

| | |
|---|---|
| • | For vector quantization scheme, the format and size of the VQ codebook, the |
| | distance metric (or quantization rule), the segmentation approach, and |
| | configuration of VQ codebook. |
| • | For scaler quantization scheme including uniform and non-uniform quantization |

[Note][*] “output-CSI-UE”: reconstructed output CSI assumed at UE, a term used for
Type 3 Separate training.
[**] “input-CSI-NW”: input CSI assumed at UE-side hypothetical AI encoder, by NW.
A term used for Type 3 Separate training.

There are some trends which deserve attention. For instance, many companies are proposing to study the potential specification impacts of the AIML-enabled CSI compression feedback format on UCI configuration.

When it comes to the input to AI-encoder at the UE side, several companies, e.g., Qualcomm (R1-2301405), NTT DOCOMO (R1-2301486), to name a few, are proposing to focus on the channel eigenvectors ([RAN1 #112] Option 1a) only. Multiple companies, i.e., Qualcomm (R1-2301405), and Apple (R1-2301913), have been proposing for UE to report eigenvalues or soft-rank as well, on top of the precoding matrix (channel eigenvectors).

Major trends and key take-aways include the following. Based on readings of 3GPP Rel-18 agreements and submitted TDOCs, the inventors have observed the following trend and possible convergence points.
1) Companies need to align on CSI feedback (especially PMI) format on UCI configuration.
2) As output-CSI-UE or input-CSI-NW, precoding matrix in spatial-frequency domain, i.e., channel eigenvectors, is considered as one of the candidates by most of the companies, hence is prioritized.
3) Several companies are proposing for the UE to deliver channel eigenvalues as well as channel eigenvectors.
4) When output-CSI-UE type is a precoding matrix, the CSI feedback can be composed into two parts similarly to the non-AIML CSI feedback, i.e., Part 1 (including CQI, RI) and Part 2 (including output-CSI-UE).
5) As for quantization of the latent vector, both scalar quantization and vector quantization are under consideration.

Regarding legacy 3GPP (non-AIML) CSI feedback, in general, CSI feedback can include the following parameters:
1) CQI (Channel Quality Indicator);
2) PMI (Precoding Matrix Indicator);
3) RI (Rank Indicator);
4) LI (layer indicator);
5) CRI (CSI-RS resource indicator).

If PMI reporting is applied, which PMI codebook to be used is configured in the CSI Report Setting. Two families of codebooks are defined for NR, namely Type I and Type II

The Type I codebooks targets Single Use Multiple Input Multiple Output (SU-MIMO) operation and offers a “regular” spatial resolution with a relatively low overhead, whereas the Type II codebooks targets Multiple User (MU-MIMO) operation and gives a much finer spatial resolution which is required for intra-cell interference suppression.

A CSI report comprises of two parts. Part 1 has a fixed payload size and is used to report some of the CSI parameters and, for Type-II reporting, to identify the number of information bits in Part 2. Part 1 shall be transmitted entirely before Part 2 [see 3GPP TS 38.214, 5.2.3]. Additional information is as follows:
1) CSI Part 1—fixed payload size (decoding at gNB without prior information);
2) CSI Part 2—variable payload size for Type-II reporting, based on information in Part 1.

For Rel-16 Type II CSI feedback, Part 1 contains RI (if reported), CQI, and an indication of the total number of nonzero coefficients, (see Clause 5.2.2.2.5 of 3GPP TS 38.214). Part 2 contains the PMI.

The reason why the PMI payload in Type-II reporting has variable size is because a CSI reporting setting configures a parameter combination which determines a maximum payload size, but a UE can report a smaller size PMI depending on the output of the compression operation for a CSI-RS measurement occasion.

When it comes to the current 3GPP Rel-18 SI with respect to AIML for CSI feedback enhancements, it is anticipated that the AIML-enabled CSI feedback can improve performance (in terms of feedback overhead reduction and/or DL throughput increase) especially for a MU-MIMO case.

An AIML-supported CSI feedback scheme would most likely lead to a latent vector of which the format may not be necessarily compatible with the current 3GPP specification (Rel-15, Rel-16, Rel-17) defined PMI feedback format, i.e., DFT precoder or type II codebook.

When it comes to the CSI feedback that is required to be conveyed from UE to NW over the air interface, data compression and quantization are important topics. As is depicted in FIG. 2, the original DL channel information (possibly after pre-processing, e.g., SVD; channel eigenvector estimate, for example) can be compressed to a latent vector (e.g., codeword) 235 via an AI encoder 230 at the UE side. This output of the AI encoder is to be delivered to the NW, after quantization by quantizer 240 (note that depending on UE side AI encoder design, this quantization procedure can be integrated into the AI encoder). At the NW side, the reverse procedures are executed, i.e., dequantization using dequantizer 250, AI decoding by AI decoder 260, to be followed by possibly a post-processing 265 to acquire a final target CSI 280, e.g., precoding matrix for subsequent DL MIMO processing.

Here, it is expected that the format of the AI encoder output, i.e., the latent vector (codeword), is dependent on the compression ratio (CR), the structure of (especially) the final few layers and the activation layer to the output of the AI encoder. This latent vector needs to be mapped to a bit sequence corresponding to CSI feedback as one of the contents of UCI (Uplink Control Information). The structure/format of the latent vector and its mapping to the bit sequence need to be defined for AIML supported CSI feedback in the 3GPP specification, as this CSI feedback information shall be sent over the air as one of the UCI contents.

Current 3GPP CSI feedback fields definitions, especially PMI information fields, does not seem to be appropriate to represent the AI encoder output, i.e., the latent feature vector. Since the legacy CSI feedback is in large based on the predefined codebook (PMI is the index referring to the predefined fixed codebook), the format of the AI encoder output cannot be put into a rigid format (at least at the time of this writing), as it should be applicable to various AI encoder formats and their inside structures, which UE vendors would like to keep proprietary for competitive advantage of their design.

One thing that can be safely assumed is that the AI encoder output should be of the form of a vector (note that any multi-dimensional tensor can be unfolded into the vector format in the end, and the order of unfolding can be assumed to be learned by AI decoder training). A format for the AI encoder output codeword and its mapping rule to bit sequence should be defined to support over the air signaling of AI encoder output for AIML supported CSI feedback compression. It should be noted that, as UE-vendors would not want to reveal their proprietary AI encoder design details, this latent vector format should be flexible enough to be capable of representing possibly various AI encoder models/structures.

As one can see from the legacy CSI reporting design described above, it is assumed that CSI feedback is expressed using known formulas, has strictly defined structure, and has a certain level of robustness when reported over wireless channels.

However, no particular implementation of ML encoder-decoder is to be standardized in 3GPP. It can only be expected that the format of the compressed information (output of the encoder) will be specified to certain degree (e.g., number of reported bits).

ML-based approaches to CSI reporting have high flexibility that can cause the following issues:
1) The gNB needs to know the payload size of the Uplink Control Information (UCI) carrying CSI report in order to avoid blind decoding of the transmission.
a) In the legacy non-ML CSI feedback, the payload of CSI Part 1 is fixed and also contains the necessary indication to determine the size of CSI Part 2.
b) The exact structure of the ML CSI feedback is not yet defined in 3GPP. At least the length (number of bits) is expected to require specification and is For Future Study (FFS).
2) Different ML-enabled CSI feedback compression configurations can be used that will define the size of the payload (e.g., compression ratio). Compression ratio is not currently defined for the CSI feedback.
a) Novel PMI (Precoding Matrix Information) format for AIML-enabled CSI compression should be flexible enough to handle various AI encoder outputs, of which one common thing is that they should be represented by a latent vector format.
b) PMI latent vector (codeword) to bit sequence mapping should be flexible enough to cover both SQ (scalar quantization) and VQ (vector quantization) cases.
c) PMI format should be able to be augmented, if configured, to contain channel eigenvalues, as well as channel eigenvectors.
d) To facilitate AI-decoder training, it is beneficial to reduce ambiguity in interpretation of the bit sequence of the CSI feedback. In this sense, some guidance should be provided, i.e., how to map/decode the bit sequence to get information about channel eigenvector(s), channel eigenvalue(s), if available, and channel rank.

Current 3GPP-defined CSI feedback format (especially PMI format, TS38.214) is not appropriate (or is too rigid) for AI/ML supported CSI feedback compression scheme, due at least to the following reasons:
1) Current 3GPP CSI feedback format is based on either the predefined codebook (PMI matrix) or the predefined beam forming equation which is known to UE and NW (Type II codebook).
2) UE vendors would not reveal their proprietary AI encoder details, e.g., type of neural network backbone, e.g., fully connected layer, CNN, transformer, or the like, number of layers and dimensions, type of activation functions, or the like, for the sake of their competitive advantage.
3) It is very difficult to enforce a certain rigid format on the output of possibly various AI encoder models, of which the internal structure is not known.

In short, AI encoder output can have various format, which cannot easily be formulated by the common equation or the predefined limited codebook elements. This is due to the fact that the AI encoder output (the latent feature vector) would be shaped by the specific AI encoder model (type of neural network, number of layers and dimensions, type of activation functions, or the like) and used training dataset.

Legacy UE procedures for reporting channel state information (CSI), including reporting settings and PMI reporting using (enhanced) Type II Codebook is standardized in 3GPP TS 38.214, Clause 5.2. UCI mapping to PUSCH and PUCCH is standardized in 3GPP TS 38.212. No procedures or formats defining the ML-based CSI the feedback are yet agreed to.

At a broad level, the examples herein address one or more of the following challenges:
1) How to combine reporting of ML-enabled/compressed parts of CSI report with legacy non-ML parts.
2) How to configure and provide scalable, and flexible AIML-enabled CSI (especially PMI) reporting without additional signaling overhead.
3) How to design an efficient and flexible PMI format suitable for AIML-enabled CSI feedback, addressing all the major agreements and major trends at 3GPP Rel-18 SI so far.

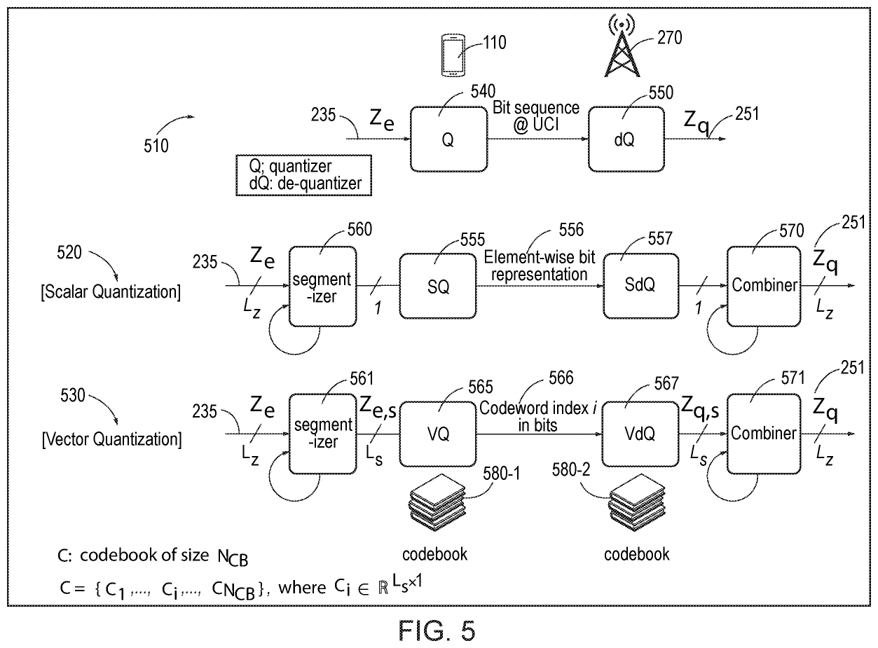

Before proceeding with an overview of the examples herein, it is helpful to discuss the possible quantization types and focus areas of the examples herein. As depicted in FIG. 5, as indicated by reference 510, the AI encoder output (e.g., latent feature vector zₑ 235) should be quantized to be transmitted over the air from UE-side (with UE 110) to the NW-side (with network element 270). A quantizer (Q) 540 quantizes the latent feature vector zₑ 235 to create a bit sequence included in UCI, and a de-quantizer (dQ) 550 at the network element 270 creates latent feature vector z_{q} 251.

There can be two kinds of quantization schemes, i.e., scalar quantization (SQ) 520, and vector quantization (VQ) scheme 530. The scalar quantization scheme 520 quantizes each element of the latent vector, one-by-one. The latent feature vector zₑ 235 has Lz parallel dimensions and a segmentizer 560 produces a one-dimension (i.e., scalar) bitstream that is operated on by the scalar quantizer 555, and there is an element-wise bit representation 556 that is then operated on by the scaler de-quantizer 557, which produces a single dimension bitstream output that is combined by combiner 570 into the latent feature vector z_{q} 251 that has Lz dimensions. Each bitstream can be represented using a scalar value, which itself can be represented by various numbers of bits.

A vector quantization scheme 530 quantizes a certain predefined number (Ls) of elements in a bundle, by looking up the predefined codebook which is shared by UE-side and NW-side. Note that for VQ of AI-encoder output latent vector, segmentation may be required to render a VQ task manageable. This means that the overall latent vector (of which the dimension (Lz) can be as high as 64, or even larger than 100, depending on input size and CR) should be segmented into multiple of the small size (Ls) subvectors, e.g., dimension of 2,3,4, for example. In FIG. 5, the vector quantization scheme 530 uses the latent feature vector zₑ 235 that has Lz parallel dimensions and a segmentizer 561 that produces small (Ls) subvectors to produce subvectors z_{e,s} having Ls dimensions. The vector quantizer 565 quantizes these into codeword indexes i 566 in bits, which are operated on by the vector de-quantizer 567 to produce the subvectors z_{q,s} having Ls dimensions, which are combined by the combiner 571 into the latent feature vector z_{q} 251 that has Lz dimensions.

These examples have codebook 580-1 being used by the UE 110 and codebook 580-2 being used by the network element 270. The codebook C 580 has a size of NCB, and the codebook is represented by {C₁, . . . , Cᵢ, . . . , C_{N}_{_{CB}}}, where Cᵢ∈□^{L}^{_{S}}^{×1}.

Examples herein address how to represent a bit sequence efficiently at UCI, which is subject of future 3GPP specification, as a part of air interface signaling definition. As an overview, payload-efficient (and also flexible) bit sequence formulation scheme is proposed in an example for AIML supported CSI compression.

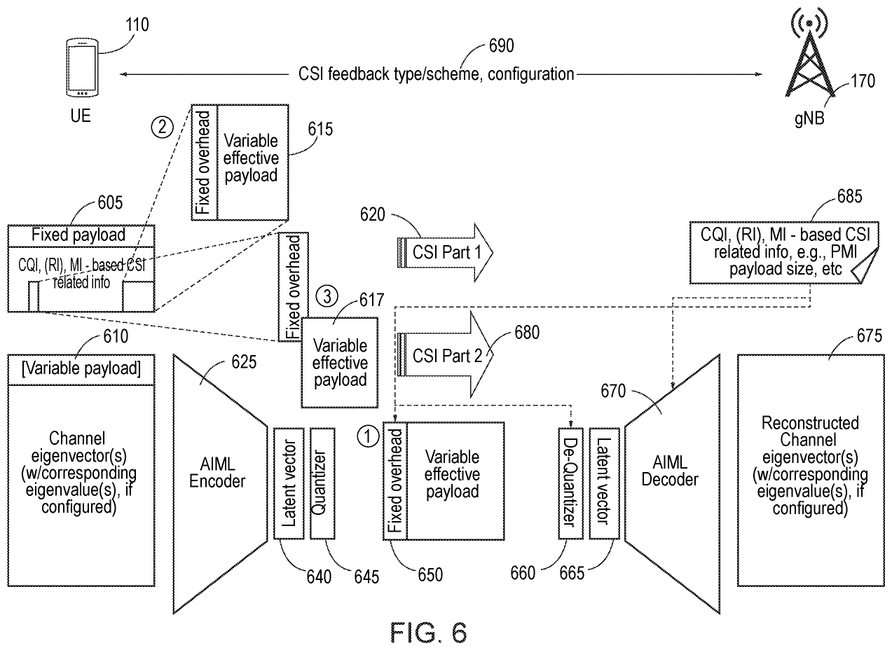

Before proceeding with additional description, it is helpful to describe an AIML-enabled CSI feedback format with a legacy split into CSI Part 1 620 and CSI Part 2 680. See FIG. 6. This figure discusses CSI Part 1 and Part 2, and the current definition of these can be found in 3GPP TS 38.214 (see, e.g., 3GPP TS 38.214 V17.5.0 (2023 March)). There is a fixed payload 605, containing CQI, RI, ML-based CSI and related information, where parts 615 contain fixed overhead but variable effective payload. Variable payload 610 may include channel eigenvector(s) with corresponding eigenvalue(s) if configured with these, which are fed into an AIML encoder 625. The AIML encoder 625 outputs a latent vector 640, which passes through a quantizer 645, which outputs a part 650 having fixed overhead and variable effective payload. The fixed overhead may include CQI, RI, ML-based CSI related information (info), such as PMI, payload size, and the like (which may also be used in de-quantizer 660 and AIML decoder 670). The part 650 is de-quantized by the de-quantizer 660, to form a latent vector 665, which is decoded by AIML decoder 670, which produces reconstructed channel eigenvector(s) 675 with corresponding eigenvalue(s) if configured with these. There is signaling 690, between the UE 110 and gNB 170, comprising CSI feedback type/scheme and configuration.

The bit sequence formulation scheme herein been designed by considering the following.
1) Channel eigenvector is the most popular candidate for AIML-enabled compression. Furthermore, dominant eigenvector possibly has the most critical impact to performance, whereas other eigenvectors are less critical.
2) Channel eigenvalue can be useful for gNB-side DL-MIMO processing.
3) Dimension of latent vector can be variable, depending on size of input to AI encoder, compression ratio, AI encoder architecture, or the like.
4) For certain cases, SQ can be beneficial over VQ, as SQ does not require pre-defined codebook sharing between UE vendor and gNB vendor, and its mapping from the latent vector to bit sequence is straightforward.
5) Other than PMI, CQI and RI can be kept as in the legacy CSI feedback.

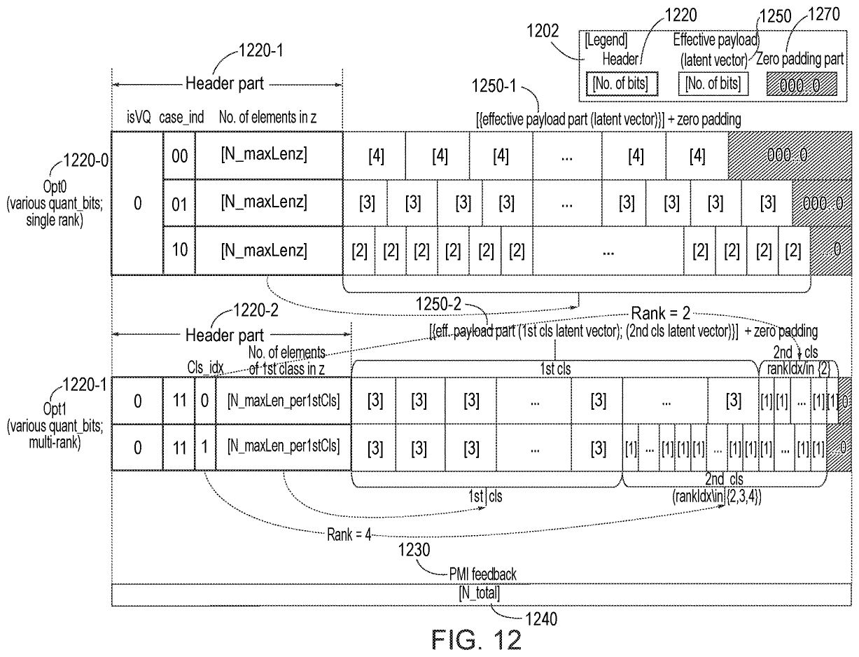

This may be achieved by one or more of the following:
1) Pre-defined, plural number of payload sizes of the Uplink Control Information (UCI) carrying CSI report, e.g., {64, 128, 256, 384, 512, 768} [bits] as the whole container, to cover various resolution, latent vector size, compression ratios. Note that these plural payload sizes will have associated maximum sizes (e.g., {64, 128, 256, 384, 512, 768} [bits]), and the plural payload sizes may be associated with different configurations indicated by the network to a UE.
2) Division of CSI feedback into the header part and the effective payload part.
a) Header part of the fixed size and clear definition provides an instruction how to decode the following effective payload part. Note that part of the information on how to interpret the variable payload of the CSI report may be specific to an encoder model ID and indicated by a UE in an encoder model ID description or as assistance information associated, for example, with a dataset for initial training provided by a UE to the network. Refer to “possible alternatives” below for the detailed description, which may be found by the description of “Possible alternatives are discussed now.”
b) Effective payload part: contains the actual quantization output in bit sequence.
3) Supporting flexibility of arbitrary number of feature vector elements and (pre-defined) word length (in case of SQ) or codebook size (in case of VQ) options for effective payload part. The term “arbitrary” in this context means any number can be set, as long as that number fits within the pre-defined “maximum” payload size. It is also noted that the term “word length” is use to indicate the number of bits to use in representing a fixed-point number of the latent vector element value.
4) Supporting flexibility of allocating different number of bits (capability of various quantization resolution support). It is note that quantization resolutions may also be referred to as quantization granularities. A use case for this is higher number of bits for the dominant eigenvector compression, lower number of bits for non-dominant eigenvector(s) compression.
5) Supporting both SQ and VQ schemes with unified bit sequence encoding methodology.
a) This allows one common format both for SQ and VQ with repurposed parameter definition.
b) This also allows unified UCI decoding scheme for PMI interpretation at the gNB 170/network element 270.
6) Supporting embedding of channel eigenvalues, if configured, without changing the overall PMI feedback size.
7) Having a self-contained structure (refer to FIGS. 12, 13, and 14, described below), i.e., fixed payload (header part) accompanied by a variable payload (see FIG. 6), which can be placed as a whole in its entirety into the legacy CSI Part 2 (see part 650 of FIG. 6, which is placed into CSI Part 2 680).
a) As one of other embodiments, the overall PMI can be located into CSI Part 1 in its entirety (see 615-1 of FIG. 6), or can be separated into header part and payload part to be located in a CSI Part 1 and CSI Part 2, respectively (see 615-2 of FIG. 6).
b) Other than the self-contained format, additional information, i.e., indication of the (pre-defined, limited number of) overall payload size, might be required to avoid blind decoding.

It is noted that the term “machine learning” (or ML) is intended to cover all implementations for artificial intelligence (AI) or AI/ML or any other technique that performs any type of learning by a machine. Furthermore, while CSI is mainly described herein as feedback information, any type of feedback of channel information may be implemented, such as CQI, RI, PMI, and the like. Furthermore, definition of PMI may be expanded herein to include precoding matrix information or downlink channel matrix information, which is a broader concept then just PMI in 3GPP terms.

Now that an overview has been provided, more detail is provided.

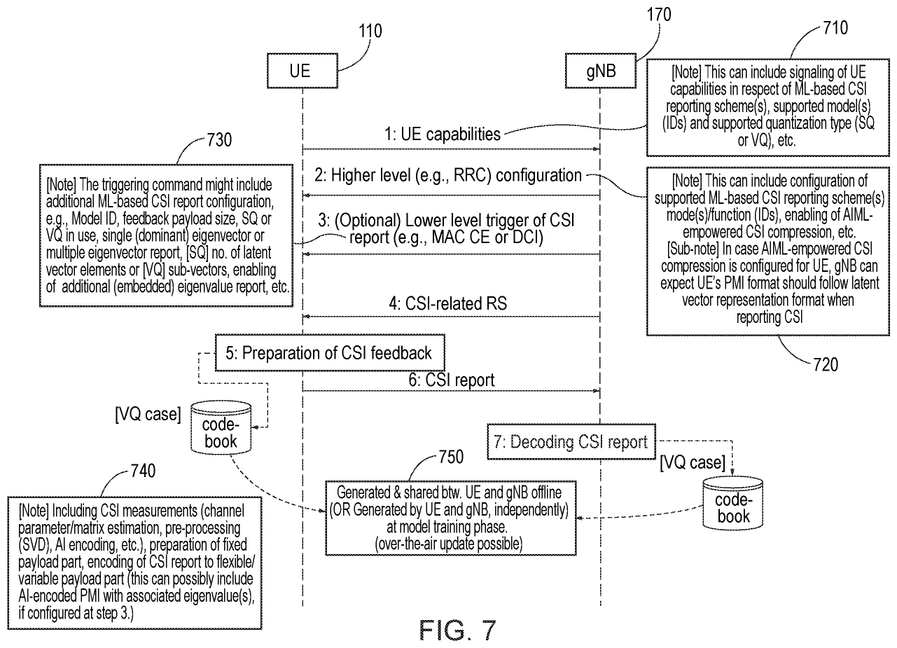

A technical advantage of the examples is a self-contained structure. Specifically, this structure:
1) Allows PMI information to be integrated into the existing legacy CSI Part 2 (or Part 1) in its entirety, or split into two parts, i.e., header part of the fixed size (into CSI Part 1), and the rest of the PMI information (effective payload followed by zero padding, if required) of the variable size (into CSI Part 2)
2) Is designed to work both the NW-initiated PMI format configuration (refer to step 3 in FIG. 7, described below) and UE-self determined PMI format cases, as the structure provides PMI configuration parameters within its self-contained structure, i.e., SQ or VQ, number of elements (implicitly compression ratio), quantization resolution, dominant channel eigenvector only reporting or full rank reporting, and optionally additional reporting of channel eigenvalues.

Another technical advantage is pre-defined various sizes of the effective payload part. This provides the following.
1) Allows to configure pre-defined variable sizes of the following:
a) Number of latent vector elements (implicitly determines compression ratio);
b) Number of subvectors (segmentized small-size vector; in case of VQ);
c) Latent vector information of non-dominant channel eigenvector(s) (if configured).
2) With a possible addition of (if configured by gNB) the following of channel eigenvalue(s) corresponding to channel eigenvector(s),
3) Which are derived from the system parameters such as the following:
a) Overall (pre-defined, limited numbers of) PMI feedback sizes in bits;
b) Number of allocated bits per each latent vector element (in case of SQ);
c) Dimensions of the subvector (in case of VQ);
d) Number of allocated bits per channel eigenvalues (dominant/non-dominant);
e) Support of high resolution (e.g., for dominant eigenvector/eigenvalue) and low resolution (e.g., for non-dominant eigenvector(s)/eigenvalue(s)).

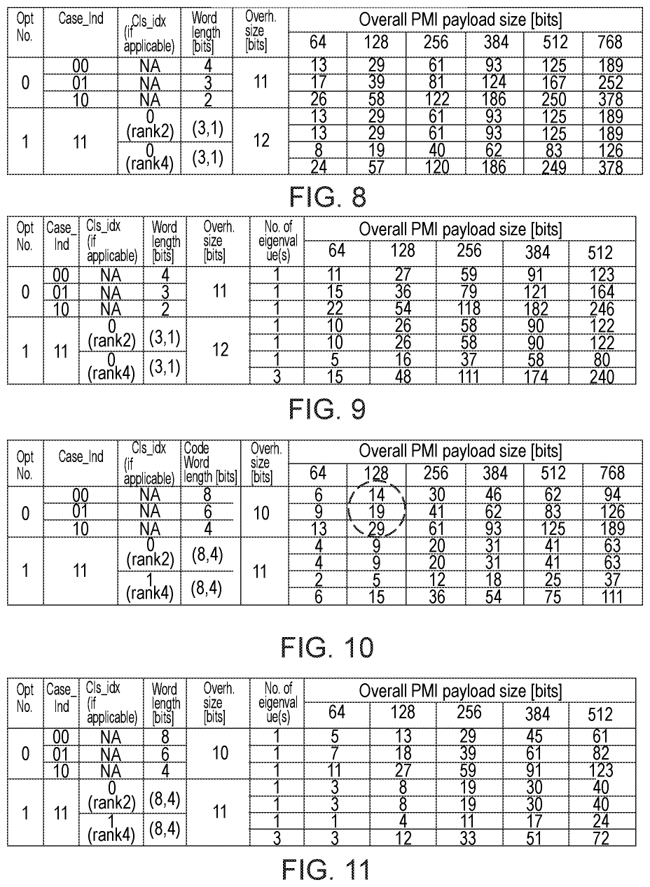

See FIGS. 8, 9, 10, and 11, described below, for examples of different payload sizes and configurations.

A further technical advantage is customized PMI format, which is suitable for representing a latent vector in an autoencoder, and may be transparent from the underlining detailed encoder architecture.

An additional technical advantage is a unified and consistent way of representing channel eigenvectors and eigenvalues in SQ and VQ format, which facilitates unified PMI interpreting/decoding flow at the gNB side.

A general CSI feedback framework (UE-gNB signaling perspective) is now described. An interaction between UE and gNB regarding CSI feedback is illustrated in FIG. 7 as an exemplary message sequence chart. That is, FIG. 7 illustrates an example of a message sequence chart between UE and gNB regarding AIML-enabled CSI reporting.

1. As a part of UE 110 capability reporting, UE may report (see block 710) its supported quantization type (SQ or VQ, or both) to the gNB 170. SQ is more straightforward to implement, as it does not require codebook generation procedure (and sharing of it with gNB vendors). VQ is known to outperform SQ in general, on the other hand. This can further include signaling of UE capabilities in respect of ML-based CSI reporting scheme(s), and supported model(s) (e.g., IDs).

2. The gNB 170, knowing UE's capability of AIML-enabled CSI compression via UE's report, commands enabling of AIML-enabled CSI compression. From this point onwards, gNB should be expecting UE's CSI feedback to be compliant to PMI format of the latent vector representation. It is noted that this can include configuration of supported ML-based CSI reporting scheme(s), mode(s)/function (IDs), enabling of AIML-empowered CSI compression, and the like. As a further note (e.g., a sub-note), in case AIML-empowered CSI compression is configured for UE, the gNB can expect UE's PMI format should follow latent vector representation format when reporting CSI. Machine-learning empowered compression (or as a more specific example, AIML-empowered CSI compression) means that one side (e.g., UE) of the communication uses certain machine language techniques for compression of the channel information such as CSI. It is noted that the other side (e.g., gNB) may or may not use the same (in terms of the underlining backbone, architecture-wise) machine language techniques for decompression of the channel information as in UE. Such machine-learning empowered compression can also include machine-learning-based reporting schemes for the channel information, such as the schemes described below (e.g., in FIGS. 8-14 16, and 17).

3. (Optional) The gNB can configure its expected PMI format in more detail, by specifying a (e.g., pre-defined, limited numbers of) feedback payload size, quantization scheme in use (SQ or VQ), dominant eigenvector-only reporting or full rank reporting, quantization scheme-dependent configuration (e.g., [SQ] number of latent vector elements or [VQ] number of subvectors (implicitly determines compression ratio)), augmented reporting of eigenvalue(s) on top of eigenvector(s). Note that in other use cases of the scheme, this step can be omitted, and thus the term “optional” is not meant to imply that other steps or processes are mandatory. In this case, UE is expected to determine the mentioned parameters on its own. As the proposed PMI format is self-contained, gNB can decode UE's PMI reporting without any ambiguity by reading its header part. Note that (see block 730) the triggering command might include additional ML-based CSI report configuration, e.g., Model ID (or possibly no Model ID), feedback payload size, SQ or VQ in use, single (dominant) eigenvector or multiple eigenvector report, [SQ] no. of latent vector elements or [VQ] subvectors, enabling of additional (embedded) eigenvalue report, and the like. Is it noted that square brackets around elements in the text and drawings should be interpreted as “in case of”, as a certain parameter field in the header part should be interpreted differently for SQ or for VQ. For example, “[SQ]:” can be interpreted into “In case of SQ, . . . ”.

4. The gNB configures and transmits CSI-RS in downlink (DL) to facilitate DL channel estimation at UE.

5. The UE estimates DL channel on CSI-RS, and performs the required pre-processing like SVD to prepare inputs to AI encoder. Then UE feeds these channel eigenvector(s) into its AI encoder. The size of the output of AI encoder, i.e., latent vector, may need to be configured to fit into gNB-configured PMI format size, if configured. All of these procedures are expected to be UE vendor proprietary. It is noted, however, see block 740, that this preparation should include CSI measurements (channel parameter/matrix estimation, pre-processing (SVD), AI encoding, and the like), preparation of fixed payload part, encoding of CSI report to flexible/variable payload part (this can possibly include AI-encoded PMI with associated eigenvalue(s), if configured at step 3.).

6. The UE reports CSI feedback to gNB. CQI, and possibly RI can follow the legacy format, whereas PMI format should follow the PMI format designed for AIML-enabled CSI compression scheme in this document. Exemplary PMI formats are illustrated in FIGS. 12, 13, and 14, described below. Note that this procedure captures the essential part of this IR.

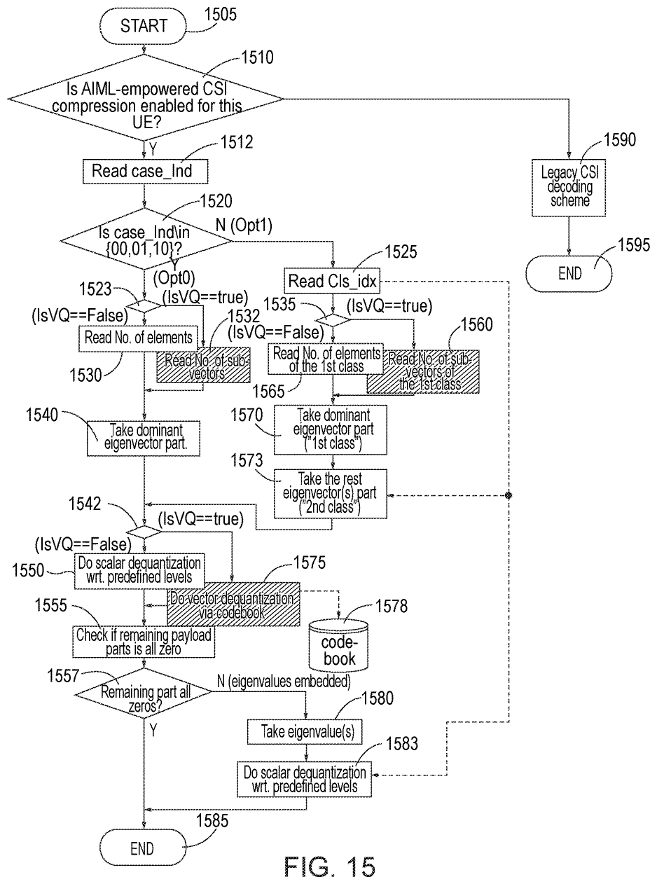

7. gNB decodes CSI feedback report upon reception (refer to FIG. 15, described below, for PMI decoding flow at gNB).

For the VQ case, which uses a codebook, block 750 applies. This codebook is generated and shared between the UE and gNB offline, typically, at the model training phase. The codebook could also, however, be generated ty the UE and gNB independently. Furthermore, an over-the-air update is possible.

What follows now is a brief description based on an exemplary use case. As stated above, the output of the AI encoder cannot be easily casted into the rigid structure or the format at least at this point. However, there are some important observations so far.

Irrespective of the DL channel configuration (antenna port number, frequency granularity, or the like), the pre-processed data to AI encoder can be transformed to be in a static format (via a dimension). Evaluation activities in the context of the Rel-18 study item show that AI training generalization works well over different number of transmit antenna ports or different layers, so an AI encoder can handle various configurations with minimum variants of its structure (if not a single one). This implies that the AI encoder output format will be transparent with respect to the layer configuration, for example.

An AI encoder can encode the pre-processed channel information (channel eigenvector may be a likely candidate), and in the case of rank >1, encoding can be done either on the dominant eigenvector only or on each eigenvector separately, for example. The output of the AI encoder can have various formats, but the output can be re-arranged/unfolded to the vector format (“latent feature vector”). The innate output structure, e.g., segmentation of the elements to I or Q parts, the order of unfolding of the high-dimension data, and the like, of the latent vector can be learned at the AI decoder training phase.

The number of elements of the latent feature vector can be different with respect to the AI encoder model details, or other configuration related variations (for example, compression ratio (CR)). Hence the format of CSI feedback should be flexible enough to cope with various latent vector sizes.

When it comes to the resolution of the elements, it has been observed that certain information (e.g., output coming from the dominant eigenvector) requires a higher resolution than others (e.g., output from higher rank (>1) eigenvectors also known as non-dominant eigenvectors). So, a certain level of selective (or discriminatory) word length (or different codebook resolution) allocation should be beneficial for the sake of efficient usage of the payload bits.

One major expected use case of an example of the scheme proposed herein is to compress the channel eigenvector via an AI encoder. As the input data has a bounded value in this case, the output of the AI encoder is expected to have a bounded value as well. Hence quantization with a relatively small number of bits, e.g., 4 bits or smaller, should be able to lead to a reasonable performance.

Based on the observations above, the following features are proposed for the format of the latent vector (to be used for signaling of the AI/ML supported CSI feedback information over the air).
1) The format should be able to represent the outcome of the AI encoder, i.e., latent feature vector, with the flexibility of the chosen quantization scheme, i.e., SQ or VQ, [SQ] the number of elements, and its word length (related with SQ resolution) or [VQ] the number of subvectors, and its codebook size (related with VQ resolution).
2) The format can provide an option to allocate a different number of bits per class, in case different resolution per class can bring about higher flexibility without compromising the performance. Here, the term class has been introduced (instead of rank as in the example above) for the sake of generalization of the concept. It is presumed that the first-class elements require higher resolution (for example: dominant channel eigenvector), whereas it is tolerable to assign smaller number of bits to the 2nd class elements (for non-dominant channel eigenvector(s)).
3) The format commands well-defined AI encoder output to UCI bit sequence mapping rule, which facilitates a clear dequantization scheme at the NW-side. There should be no ambiguity on how to interpret and group the bit sequence of the CSI feedback to reconstruct the AI encoder output on the other end of this information, i.e., NW-side after dequantization. This will greatly alleviate NW-side's burden of figuring out the grouping/segmentation of the CSI feedback bit sequence, by looking into the training data set. This will facilitate fast learning from which both AI encoder at UE-side and AI decoder at NW-side will benefit.

Design principles and considerations are now described.
1) Irrespective of multi-dimensional input format (antenna ports, time, frequency granularity) to the pre-processing to the AI encoder, the AI encoder output structure is expected to have a vector format. This should depend on the AI encoder output structure in use at the UE-side.
2) As regards the overall PMI feedback payload size, multiple (but limited numbers of) predefined fixed sizes may be offered, which are shown to be capable of supporting various configurations, e.g., various resolution, latent vector size, compression ratios, quantization scheme in use. As shown in examples illustrated in Table 1 (FIG. 8), Table 2 (FIG. 9), Table 3 (FIG. 10), and Table 4 (FIG. 11), described below, where six payload sizes already can cover multitude of configuration combinations.
3) PMI format should be able to represent SQ and VQ case in as much possible unified manner as possible.
4) One possible dominant use case for CSI compression is to encode the (dominant) first rank eigenvector only, as this vector should be able to provide good performance for the most of use cases. It is desirable to provide flexibility for the selection of multiple word lengths/codebook cardinality to cope with a various number of latent vector elements and its resolution requirements.
5) In an effort to support rank-wise CSI compression (or any processing of the similar kind requiring the output latent vector elements with various resolution), the bit sequence mapping scheme should be able to handle at least two different “classes” of output latent vector elements (each class is associated with a predefined resolution).
6) For quantization resolution, [SQ] word length of the latent vector element or [VQ] cardinality of a codebook can be pre-determined via offline investigations/experiments via simulations, or the like. Hence, the set of multiple word lengths/codebook sizes can be predefined.
7) Latent feature vector, i.e., output of AI encoder, is assumed to have a bounded value (normalized to some extent).
a) [SQ] Mapping of the latent vector element to the bit sequence of a certain predefined small size word length (4 bits per element, for example) can be done by element-wise scalar quantization.
b) [VQ] Segmenting of the latent vector element to the small size subvectors (each subvector with pre-defined number of dimensions, e.g., 4, with 2 bits/element allocation yields a 4-dim subvector codebook of size 2⁸=256) can be performed by subvector-wise vector quantization.
8) If desired, channel eigenvalue(s) can be embedded as well as channel eigenvectors. Eigenvalue is a scalar, so it can be directly quantized. One thing to note is that the eigenvalue does not have a bounded value, hence a higher number of bits, e.g., 8 for the dominant eigenvalue, might be required.

An overview of one exemplary realization method of the latent vector format and its representation in UCI can be outlined as follows. Please refer to FIGS. 12, 13, and 14 for a better understanding of the concept. Refer to FIG. 15 for PMI decoding flow example at the gNB side.

Although FIGS. 12-14 are described in more detail below, an introduction is provided now. In these figures, the number in brackets ([ ]) indicates the number of bits, whereas the number without any [ ] indicates the bit (binary) sequence itself. So, case_Ind (case indicator, or potentially case index) is allocated with 2 bits, and it can have four different values, i.e., 00, 01, 10, 11, which correspond to 0,1,2,3 decimal numbers, and these can map to the indexes and rows in FIGS. 8-11. With respect to case_Ind, there can be four difference cases, and Opt1 (see FIG. 12) (with case_Ind 11) can be further differentiated by Cls_idx (class index): 0 or 1. So FIG. 12 explains five different cases in total.

In FIG. 12, there are two options: option 1200-0 (Opt0), which is for various quantization bits (quant_bits) and for single rank; and option 1200-1 (Opt1), which is for fixed quant_bits and multiple rank (multi-rank). A legend 1202 indicates the three parts of the PMI feedback 1230 with N_total bits 1240: a header 1220 (with a number, No., of bits in square brackets); an effective payload (latent vector) 1250 (with a number, No., of bits in square brackets); and a zero-padding part 1270 (with a number of zeros for padding). The first option 1200-0 includes a header part and an effective payload part 1250-1 with a latent vector. The second option 1200-1 has a header part 1220-2 and has the effective payload part 1250-1 with a first (1^{st}) class (cls) latent vector and a second (2^{nd}) class (cls) latent vector, which holds rank IDs. For Opt1 1200-1, the “rankIdx \in (∈) {2}” means the rank index is in the set comprising 2, whereas the “rankIdx \in (∈) {2,3,4}” means the rank index is in the set comprising 2, 3, and 4. It is noted that “\in” means “element of, belongs to” (or (∈)) as used in set theory.

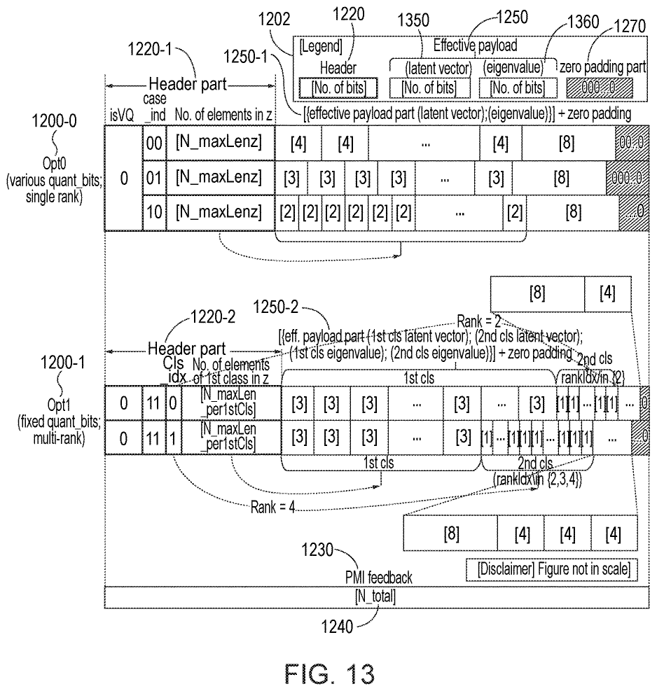

FIG. 13 is similar, but the effective payload part 1250 includes a latent vector 1350 and an eigenvalue 1360. In effective payload 1250-1, the eigenvalues 1360 are the last 8 bits before the zero padding. In effective payload 1250-2, the eigenvalues 1360 have both a first (1^{st}) class (cls) eigenvector (8 bits) and a second (2^{nd}) class (cls) eigenvector (4 bits).

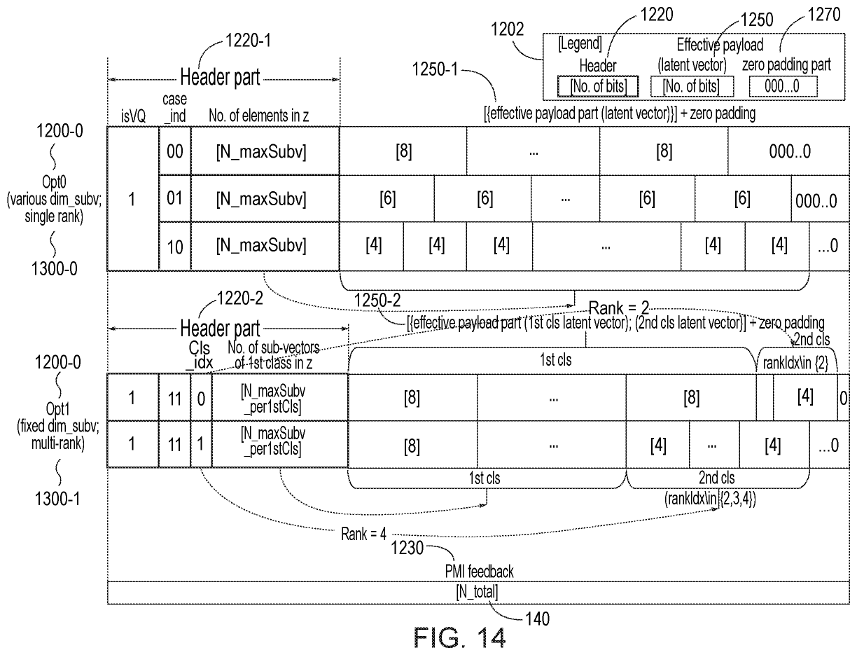

FIG. 14 is similar to FIG. 12, but option 1200-0 is for fixed (dim_subv, dimension of the subvector, also corresponding to Lₛ in FIG. 5) and for single rank; and option 1200-1, which is for fixed dim_subv and multiple rank (multi-rank).

An example of the flexible and resource-efficient format for the AI encoder output is realized by introducing a header 1220 at the beginning. The size of the header is fixed, and reading this header part gives the decoder side an introduction on how to segment the subsequent payload part which consists of the effective payload part 1250 (containing the latent feature vector elements information), and zero-padding part 1270 (filling up the remaining part of the whole bit sequence, which could also be padding of ones or other known padding values) or (optionally) additional information like channel eigenvalue(s), if configured.

The overall format can be categorized into two options, i.e., Opt0 1200-0 and Opt1 1200-1:
1) Opt0 1200-0 can be used when a single rank CSI compression (e.g., compression of the dominant channel eigenvector), or any CSI information with a single resolution level, is in use. In an effort to provide selectivity of multiple resolutions, the dedicated field (“case_Ind”) may be provided, which is associated with certain predefined resolution selections. In this particular example:
a) [SQ] {4,3,2} bits/element have been chosen for illustration purposes (see FIGS. 12 and 13).
b) [VQ] {8,6,4} bits/subvector have been chosen (see FIG. 14), with assumption of the (fixed) 2 bits/element allocation, implying {4,3,2}-dim for subvector, i.e., {4,3,2} elements per subvector.
2) In the case of Opt1 1200-1, in which two levels of resolution is supported, a combination of {high resolution word length, low-resolution word length} is considered. If multiple combinations are deemed to be necessary, “case_Ind” can be extended accordingly (with a greater number of bits than two bits in this particular example).
a) [SQ] {3,1} bit(s)/element for high resolution word length, and low-resolution word length, respectively.
b) [VQ] {8,4} bits/subvector for high resolution codebook (in terms of the number of codewords in the codebook, i.e., cardinality of the codebook), and low-resolution codebook, respectively. In this case of Opt1, dimension of subvector is assumed to be fixed, i.e., 4 for this particular example.
3) Then the number of elements in the latent feature vector (of the effective payload part 1250) field follows. That is, N_maxlen_pre1stCls states the length of the first-class part of the payload part, then the first element in the second-class states how many elements there are remaining in the payload part. Reading this field provides the NW-side with how many elements the latent vector contains. The remaining residual part at the end, after effective payload part 1250 assignment is completed, is filled up with zeros or is followed by the channel eigenvalue(s), if configured.
a) Note that Opt0 1200-0 can provide multiple word length (or codebook size for VQ) sub-options. This implies that for the given number of bits allocated for PMI representation, [SQ] the number of latent vector elements or [VQ] the number of subvectors can vary with respect to the chosen word length (or codebook size for VQ).
b) In case of Opt1 1200-1, the number of the 2nd class elements/subvectors can be pre-defined and categorized into, for example, two groups (to be indicated by the field (“Cls_Idx)). The number of the first (1^{st}) class elements (or subvectors for VQ) is configured by the dedicated field (No. of elements/subvectors of 1st class), then “Cls_Idx” field indicates how many second (2^{nd}) class elements (or subvectors for VQ) should be expected. When it comes to the actual effective payload part, the series of the designated number of the 1st class element (or subvectors for VQ) (pertinent to the dominant channel eigenvector) are followed by that of the 2nd class elements (or subvectors for VQ) (non-dominant channel eigenvector(s)).
i) Cls_Idx: 0 is the rank 2 case, i.e., the number of 2nd class elements (or subvectors for VQ) is same as the 1st class.
ii) Cls_Idx: 1 is the rank 4 case, i.e., the number of 2nd class elements (or subvectors for VQ) is 3 times of that of the 1st class.
iii) The number of [SQ] bits/element or [VQ] bits/subvector per 1st class, and 2nd class is pre-defined as [SQ] {3,1} bits or [VQ] {8,4} bits.
c) In case of the rank-wise eigenvector AI encoding example, the dominant eigenvector can be assigned to the 1st class, whereas all the other rank eigenvectors (2nd, 3rd, 4th, . . . ) can be assigned to the 2nd class. In the illustrated examples, only rank 2 case and rank 4 case are assumed, but this can be extended by allocating more bits for Cls_Idx.
d) At completion of reading the channel eigenvector part, if the remaining payload is not all-zero, then it can be assumed that channel eigenvalues are embedded (no explicit parameter is required). The number of eigenvalues is not required to be explicitly indicated via a dedicated parameter in overhead part, as it should be one (in case of Opt0 1200-0) or the same as the rank (in case of Opt1 1200-1; to be identified via Cls_Idx). An exemplary illustration of the PMI format w/embedded eigenvalue(s) for SQ case can be found in FIG. 13. It is straightforward to extend this concept to the VQ case.

A PMI format example with numbers is presented now. Practical examples of the proposed PMI format are described below. Numbers in this example have been provided for example case only, and are subject to change depending on the actual implementation practice.

System configuration parameters may be as follows. Configuration parameters below determine the overall PMI format specifics, e.g., N_maxLenz or N_maxSubv, word length of the latent vector elements (in case of SQ) or of the subvector index (in cases of VQ), or the like). These system configuration parameter values can be decided based on simulation/performance evaluation campaign by UE and NW vendors possibly within 3GPP framework, to converge into the best combinations as in the following. Note that “[Common]” indicates the parameter is common for both the SQ and VQ cases.
1) [Common] Maximum number of latent vector elements: 2⁸=256.
2) [Common] (Opt1) rank: {2,4}.
3) [Common] (optional) number of bits per eigenvalue: 8 bits for high resolution (for dominant one), 4 bits for low resolution (for non-dominant ones). Scalar quantization can be acquired directly by SVD operation. A higher number of bits can be allocated, depending on the required performance.
4) [SQ]:
a) (Opt0 1200-0) word length: {4,3,2} bits/element;
b) (Opt1 1200-1) word length per 1st class, 2nd class: (3,1) bits/element,
respectively.
5) [VQ]:
a) (Opt0 1200-0) number of bits per latent vector element: 2 bits, which is the dimension of subvector that is to be derived from pre-defined allocated bits per subvector, i.e., {8,6,4} bits/subvector, leading to {4,3,2}-dim;
b) (Opt1 1200-1) number of elements per subvector (dimension of subvector): 4, which is codebook size (cardinality of codebook) is to be derived from pre-defined allocated bits per subvector per class, i.e., {8,4} bits/subvector for 1st class and 2nd class, leading to codebook of the size {2⁸, 2⁴}={256, 16} codewords for 1st class and 2nd class, respectively. As the dimension of codeword is identical, small size codebook for 2nd class can be defined as the subset of the large size (superset) codebook for 1st class, to save memory foot print for codebook saving.

Examples of PMI formats are as follows. Example PMI formats based on the assumed system configuration parameters above are in the Tables in FIGS. 8-11 as follows: FIG. 8 is Table 1, a SQ case without channel eigenvalues], and indicates a maximum number of elements which can be packed in the given payload; FIG. 9 is Table 2, a SQ case with channel eigenvalues, and indicates maximum number of elements which can be packed in the given payload; FIG. 10 is Table 3, a VQ case without channel eigenvalues, and indicates a maximum number of subvectors which can be packed in the given payload; and FIG. 11 is Table 4, a VQ case with channel eigenvalues, and indicates a maximum number of subvectors which can be packed in the given payload. Note that the numbers in the Tables indicate the maximum number of representable elements or subvectors for the corresponding combination. Any number of elements less than those maximum number can be indicated, as the actual number of elements or subvectors can be found in the header part.

One example is not presented. For an AI encoder input of size 13 [subbands]*32 [TxAnt ports]*2 [No. of real numbers/complex variable], gNB configures the dimension of latent vector to be 120, for example. In this case, compression ratio is roughly 7 to 1. In this specific case, the available PMI payload sizes have been highlighted (using grey background) in the tables. Note that in case of VQ (Table 3, Table 4), dimensions of subvectors are {4,3,2} for Case_Ind 00, 01, 10, respectively, whereas dimension of subvector is fixed to be 4 for Case_Ind 11. Taking into account the number of latent vector elements: 120, the numbers of subvectors are {30, 40, 60} for Case_Ind 00, 01, 10, respectively, whereas the number of subvectors is 30 for Case_Ind 11.

In case of SQ for the above specific case of latent vector size of 120, channel eigenvalue(s) can be embedded without increasing the overall PMI payload size, except for Case_Ind: 10. Check the greyed entries between Table 1 and Table 2.

With 2 bits/element allocation budget (without channel eigenvalues being embedded), overall PMI payload size of 256 bits can accommodate Case_Ind: 10 of SQ case or Case_Ind: {00,01,10} (corresponding to subvector dim-{4,3,2}) of VQ case. Vector quantization of subvector with different dimension requires dedicated codebook of the same dimension. Hence selection of Case_Ind can be determined by availability of the trained and shared codebook of the associated dimension and/or performance evaluation results.

Consider an example. For the same AI encoder size as the above one (13*32*2), gNB configures the dimension of latent vector to be 58 (CR=~14.3) due to a better AI decoder (and/or AI encoder) capability or higher SINR condition than the above case.

In this case, VQ scheme leads to the number of subvectors of {15,20,29} for Case_Ind 00, 01, 10, respectively, whereas the number of subvector is 15 for Case_Ind 11, when allowing no truncation of the latent vector elements, i.e., ceil (58/[4 3 2])=[15 20 29], where “ceil” is the ceiling function. This forces a selection of 256 bits overall PMI overhead case for VQ without channel eigenvalue being embedded (Table 3). However, if one allows a loss of the last two or one latent vector element(s) for subvector dim-4 or dim-3, respectively, one can pack them into 128 bits PMI payload size, i.e., floor (58/[4 3 2])=[14 19 29], where “floor” is the floor function. Relevant cases are surrounded by a dashed oval. There can be a trade-off between integrity of PMI feedback and UL overhead.

Turning to FIG. 15, this figure illustrates a PMI decoding flow example, such as performed by a network element such as a gNB 170. It should be noted that while FIG. 15 depicts a decoding example, an encoding procedure should follow the same steps. Above, a comment was made that examples herein can support both SQ and VQ schemes with unified bit sequence encoding methodology. As can be observed in FIG. 15, both SQ and VQ cases follow very similar flows for bit sequence generation. For example, VQ case follows paths through 1532, 1560, and 1575 only when isVQ==true, but all the other paths are identical both for SQ and VQ cases in FIG. 15.

The flow in FIG. 15 starts in block 1505, and in block 1510, it is determined whether an AIML-empowered CSI compression is enabled for this UE. If not (block 1510=N), a legacy CSI decoding scheme is used in block 1590 and the method ends in block 1595.

If CSI compression is enabled for this UE (block 1510=Y), the gNB 170 reads the case_Ind in block 1512. In block 1520, it is determined whether the case_Ind (e.g., case indicator) is in {00,01,10}. If not (block 1520=N (Opt 1)), option Opt 1 1200-1 is known to be used, and in block 1525, the gNB reads Cls_idx (e.g., a class index), and if IsVQ in block 1535 is true, the gNB in block 1560 reads the number (No.) of subvectors of the first (1^{st}) class, otherwise (IsVQ=False) the gNB reads the number of elements of the first (1^{st}) class in block 1565. The Cls_idx that has been read is input to blocks 1573 and 1583. The flow proceeds to block 1570, where the gNB takes the dominant eigenvector or part (the “1^{st} class”), and in block 1573, the gNB takes the rest eigenvector(s) part (the “2^{nd} class”). The flow proceeds to block 1542.

If, in block 1520 it is determined the case_Ind is in the set of {00,01,10} (block 1520=Y (Opt 0)), option Opt 0 1200-0 is known to be used, and in block 1532, the gNB reads the number of subvectors if IsVQ in block 1523 is true, otherwise (IsVQ=False) the gNB reads the number of elements in block 1530. The flow proceeds to block 1540, where the gNB takes the dominant eigenvector part.

Both blocks 1540 and 1573 lead to block 1542, where if IsVQ is true, the gNB performs vector dequantization via the codebook 1578 in block 1575. If IsVO is false, the gNB performs scalar dequantization with respect to (wrt.) predefined levels in block 1550. In block 1555, the gNB checks if remaining payload is all zero. If the remaining payload is not all zero (block 1157=N (eigenvalues embedded), the gNB takes the eigenvalue(s) in block 1580 and performs scalar dequantization with respect to predefined levels in block 1583. If the remaining part are all zeros (block 1557=Y), and from block 1583, the flow ends in block 1585.

Possible alternatives are discussed now. One such alternative is header part re-purposing in association with model ID for interpretation of the variable payload part. That is, signaling a specific model ID may cause different interpretation (e.g., for the payload part) as compared to interpretation for other model IDs or possibly no model ID being signaled.

Part of the information on how to interpret the variable payload of the CSI report may be specific to an encoder model ID and indicated by a UE in an encoder model ID description or as assistance information associated, for example, with a dataset for initial training provided by a UE to the network. As an example, an ML encoder model may compress the PMI for rank 4 (rankIdx∈{1,2,3,4}), each rank elements with 3 bits by a predefined SQ (rather than 1st/2nd classification, e.g., 3 bits per rankIdx:1, whereas all other rankIdx with 1 bit). When a previous arrangement has been made between UE and NW via a specific encoder model ID, this can be represented/interpreted either by an alternative to Opt0, i.e., single rank option is repurposed to represent multi-rank case within the framework of an identical (e.g., same) bit resolution per each element representation, or by an alternative to Opt1, i.e., 1st and 2nd class concept is repurposed to represent the (class-less) identical (e.g., same) resolution within the framework of a multi-rank representation.

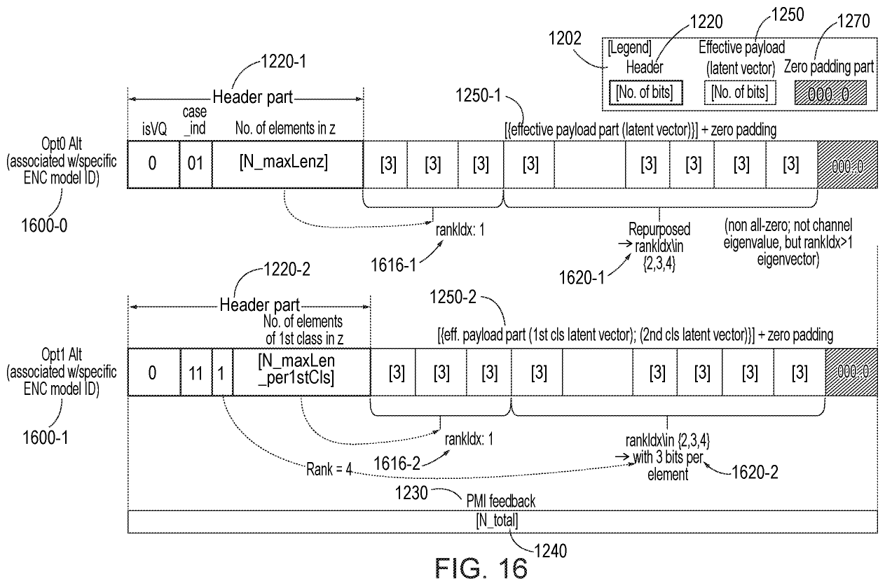

Refer to FIG. 16 for better understanding. FIG. 16 is similar to FIG. 13, except the first option Opt0 1600-0 is an alternative (alt) and is associated with a specific ENC (encoder) model ID, while the second option Opt1 1600-1 is an alternative (alt) and is associated with a specific ENC (encoder) model ID. The Opt0 1600-0 alternative uses rankIdx: 1 1616-1 for the first three elements of the effective payload part 1250-1 and uses (see 1620-1) rankIdx in the set of {2,3.4}, where these are non all-zero (e.g., some are not zero), and are not channel eigenvalue but instead rankIdx>1 eigenvectors. The Opt1 1600-1 alternative uses rankIdx: 1 1616-1 for the first three elements of the effective payload part 1250-1 and uses (see 1620-2) rankIdx in the set of {2,3.4}, with three bits per element. In comparison with FIG. 13, after designated number of elements, the following non-zero information is supposed to indicate eigenvalue in FIG. 13. In case of FIG. 16, however, this non-all-zero part indicates eigenvector-part information (in which rankIdx>1), rather than channel eigenvalue, when associated with specific encoder model ID.

Furthermore, the isVQ, case_Ind, Cls_idx fields can be combined into one identifier. The concept can be extended to cover various word length pairs (and/or various ratio of the 1st class elements) for Opt1, if needed, at the cost of the increased overhead size (“Cls_idx” field needs to be extended). The term “word length pair” indicates a pair of the word length of the 1^{st} class latent vector and the word length of the 2^{nd} class latent vector. In the illustrated example of FIG. 14, only one pair, i.e., (8,4), is shown. This concept can be extended by supporting various pairs, e.g., (8,4), (6,4), (3,1), and the like, by allocating more bits in the header part.

Additionally, more levels of rank can be covered for Opt1 case, e.g., rank 3, . . . , 8, or the like. More combination of (high resolution, low resolution) number of bits can be supported. A number of supported classes can be extended, e.g., introduction of 3rd class with smaller number of bits than 2nd class, or the like.

In case of Opt0 for a VQ case, dimension of subvector can be fixed, e.g., dim-4, instead of the constant number of bits/element (2 for the specific example in this document) for bit allocations of {8,6,4}, for example. This leads to various bits/element configurations, i.e., {2,1.5,1} bit(s)/element resolutions (codebook sizes of {256, 64, 16} for dim-4 vector quantization, respectively).

In case of Opt1 for VQ case, the number of bits/element can be fixed, e.g., 2, instead of the constant dimension of subvector (4 for the specific example in this document) for bit allocations of {8,4} per the 1st class and the 2nd class subvectors, for example. This leads to various subvector dimension configurations, i.e., {4,2}-dim per the 1st class and the 2nd class subvectors.

In case of Opt1, a same number of bits can be allocated to 1st class and 2nd class (same resolution), if this is deemed to be beneficial. For representation of channel eigenvalue(s), floating point or fixed-point format can be used.

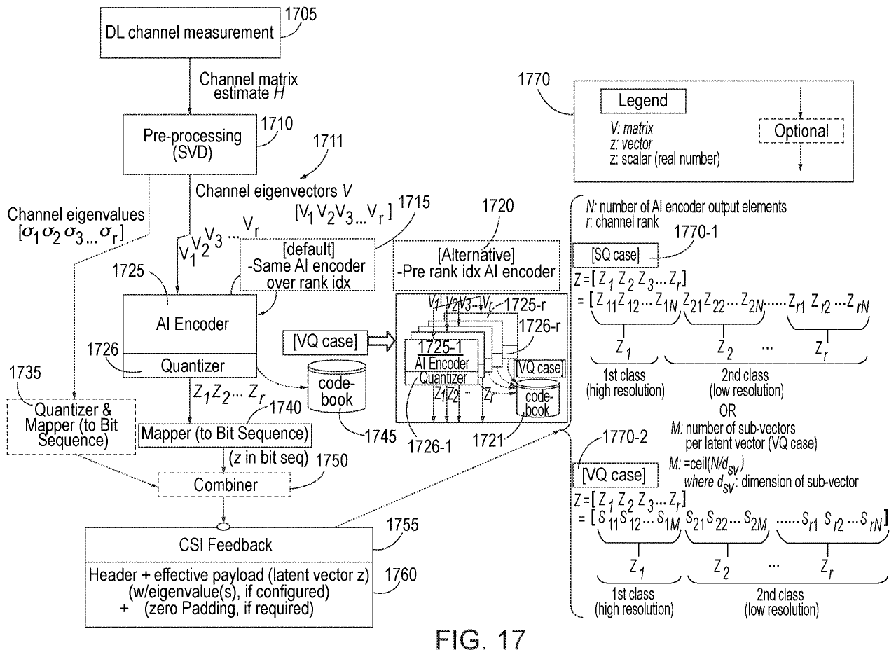

UE-side operation is now described for multi-rank channel compression via rank-wise eigenvector AI encoding. One generic example of AI encoder for CSI feedback is depicted in FIG. 17, which illustrates an example use case of rank-wise eigenvector AI encoding. As indicated by block 1770, The letter V (in bold font) is used to indicate a matrix, a lowercase z in bold font is used to indicate a vector, and a lowercase z in regular font is a scalar, e.g., a real number and an element of a vector. Blocks that are dashed are optional, which does not mean other blocks or corresponding operations are required, only that the optional blocks are more relevant for certain implementations.

First, the UE performs DL channel measurement in block 1705, which forms the channel matrix H. In this example, the raw channel estimate is pre-processed to reveal its spatial structure by performing SVD (singular value decomposition). See block 1710. As a result, UE can acquire as output 1711 the channel eigenvector(s) as well as the channel eigenvalue(s). This example has channel eigenvectors of V=[ν₁ ν₂ ν₃ . . . νᵣ], and channel eigenvalues of [σ₁ σ₂ σ₃ . . . σᵣ]. In case of rank-wise AI encoding, each eigenvector (νᵢ, i∈{1, 2, . . . , r}, where r is the rank of the channel) is being fed into the AI encoder (block 1725) one by one, and its output latent feature vector (zᵢ) is concatenated to form the aggregate vector output (z). Note here that for the output of the dominant eigenvector, higher number of word length (“1st class”) can be used whereas lower number of word length (“2nd class”) can be used for all the other outputs, to be bit-resource efficient. The quantizer 1726 quantizes (using the codebook 1745 in the VQ case) the output of the AI encoder, creating vectors [z₁ z₂ . . . zᵣ]. A mapper 1740 maps these vectors to bit sequences, the vectors z in bit sequences.

Note that after pre-processing (like SVD), the channel eigenvalue(s) can be acquired as well as the channel eigenvector(s). Depending on the implementation practice or algorithm features, the channel eigenvalue(s) might need to be signaled to the NW-side as well (this can be explicitly enabled by gNB, e.g., via step 3. in FIG. 7). In this case, the channel eigenvalue(s) can be quantized and embedded into the PMI payload as proposed in an example.

Note here that individual channel eigenvectors [σ₁ σ₂ σ₃ . . . σᵣ] can be AI-encoded either by using the same AI encoder 1715 (with identical trained parameters) irrespective of its rank index, or can be encoded by using the dedicated rank-wise AI encoder 1720. For the latter case, rank-specific codebooks 1721, along with rank-specific trained parameters for AI-encoder, might be also required for better performance in case of VQ. For this example, each eigenvector has its own AI encoder 1725 and quantizer 1726 for each of the r vectors, such that there are AI encoders 1725-1 through 1725-r and quantizers 1726-1 through 1726-r. If the channel eigenvectors [σ₁ σ₂ σ₃ . . . σᵣ] are used, then block 1735 involves quantizing and mapping the channel eigenvectors to bit sequences, and a combiner 1750 is used to combine bit sequences from the bit sequences of vectors z from block 1740 and bit sequences from block 1735. Note also that in case of VQ, the latent vector (z) is segmentized to multiple subvectors (sᵢ) of the identical dimension size.

The CSI feedback 1755 is illustrated, and block 1760 indicates this is a header plus (+) effective payload (e.g., the latent vector z) (with, w/, eigenvalue(s), if configured), and with zero padding, if required. In the SQ case 1770-1, N is the number of AI encoder output elements, and r is the channel rank. Then z=[z₁ z₂ z₃ . . . zᵣ], [z=z₁₁ z₁₂ . . . z₁ₙ z₂₁ z₂₂ . . . z₂ₙ . . . zᵣ₁ zᵣ₂ . . . z_{rN}], where z₁, z₂, . . . , zᵣ are as illustrated in FIGS. 17, and z₁ is the 1^{st} class (high resolution), while z₂, . . . , zᵣ are 2^{nd} class (low resolution).

In the VQ case 1770-2, M is a number of subvectors per latent vector (the VQ case), M=ceil(N/d_{SV}), where d_{SV} is a dimension of a subvector. Then z=[z₁ z₂ z₃ . . . zᵣ], [z=z₁₁ z₁₂ . . . z_{1M} z₂₁ z₂₂ . . . z_{2M} . . . zᵣ₁ zᵣ₂ . . . z_{rM}], where z₁, z₂, . . . , zᵣ are as illustrated in FIGS. 17, and z₁ is the 1^{st} class (high resolution), while z₂, . . . , zᵣ are 2^{nd} class (low resolution). That is, for the SQ case, (non-bold, small character) z indicates a scalar. A collection of z constitutes a latent vector (bold, small character z with one digit subscript). For the VQ case, (bold, small character) s indicates a vector (it refers to a subvector). A collection of (bold, small character) s constitutes a latent vector (bold, small character z with one digit subscript).

The following are additional examples.

Example 1. A method, comprising: reporting, at a user equipment, a capability to a network entity, wherein the capability comprises one or more supported quantization types for feedback of channel state information; receiving, at the user equipment, configuration from the network entity, wherein the configuration comprises at least information enabling of machine-learning-enabled compression for the channel state information and corresponds to the one or more supported quantization types; and reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

Example 2. The method according to example 1, wherein the first part has fixed size and format.

Example 3. The method according to any one of examples 1 or 2, wherein the second part has a variable size with a maximum size determined by network configuration.

Example 4. The method according to example 3, wherein the feedback has a fixed payload size, the first part and second part fit within the fixed payload size, and any part of the fixed payload size that is not occupied by the first part and second part is occupied by padding.

Example 5. The method according to any one of examples 1 to 3, wherein the second part has a variable format defined by parameters in the first part to enable the second part to be applicable to multiple different machine learning models for generation of the channel state information, multiple different machine learning models for reconstruction of the channel state information, or machine learning model pairs for generation and reconstruction of the channel state information.

Example 6. The method according to any one of examples 1 to 5, wherein a part of a description of the format for precoding matrix information designed for the machine-learning-enabled compression is indicated separately by the user equipment in description comprising an encoder model identification or as assistance information which is associated with a dataset for initial training provided by the user equipment to the network entity.

Example 7. The method according to any one of examples 1 to 6, wherein the format for precoding matrix information is in one of a plurality of pre-defined payload sizes having a maximum number bits for an uplink control information carrying the channel state information.

Example 8. The method according to any one of examples 1 to 7, wherein the second part includes actual quantization output in bit sequence.

Example 9. The method according to any one of examples 1 to 8, wherein the second part, as defined at least in part by parameters in the first part, supports multiple numbers of feature vector elements and word length in case of a supported quantization type of scalar quantization or codebook size in case of a supported quantization type of a vector quantization.

Example 10. The method according to any one of examples 1 to 9, wherein the second part, as defined at least in part by parameters in the first part, supports allocating a different number of bits for different quantization resolutions.

Example 11. The method according to any one of examples 1 to 10, wherein the second part, as defined at least in part by parameters in the first part, supports both scalar quantization and vector quantization schemes as supported quantization types with unified bit sequence encoding methodology.

Example 12. The method according to any one of examples 1 to 11, wherein the second part, as defined at least in part by parameters in the first part, supports embedding of channel eigenvalues without changing overall feedback size of the precoding matrix information.

Example 13. The method according to any one of examples 1 to 12, wherein the first and second parts are located into Channel State Information (CSI) Part 1 in their entirety, are located in CSI Part 2 in their entirety, or the first part is located in a CSI Part 1 and the second part located in CSI Part 2.

Example 14. The method according to any one of examples 1 to 13, wherein the first and second parts correspond to a specific encoder model identification indicated by the user equipment to the network entity, the second part comprises information to be interpreted differently as compared to where the first and second parts correspond to other encoder model identifications or no encoder model identification.

Example 15. The method according to example 14, wherein the second part represents a multi-rank case, instead of being a single rank option, within a framework of a same bit resolution per each element representation, or the second part represents a class-less same resolution, instead of first-class and second-classes, a framework of a multi-rank representation.

Example 16. The method according to example 14, wherein the second part comprises information indicating eigenvector-part information, in which a rank index is greater than one, rather than channel eigenvalues.

Example 17. The method according to any one of examples 1 to 16, wherein the format for precoding matrix information provides parameters, within a self-contained structure for the precoding matrix information, for a supported quantization type of scalar quantization or vector quantization, provides a number of elements in the second part, provides quantization resolution, provides dominant channel eigenvector only reporting or full rank reporting, and provides additional reporting of channel eigenvalues for certain configurations enabling the additional reporting.

Example 18. The method according to any one of examples 1 to 17, wherein the receiving configuration comprises receiving one or more of the following: additional machine-learning-based report configuration for feedback of the channel state information; feedback payload size; whether scalar quantization or vector quantization is in use as the one or more supported quantization types; whether single dominant eigenvector reports or multiple eigenvector reports are to be reported for the feedback; for scalar quantization, a number of latent vector elements; or for vector quantization, number of subvectors; or enabling of additional eigenvalue reports.

Example 19. The method according to any one of examples 1 to 18, wherein reporting the feedback further comprises encoding a report containing the feedback so the second part includes one of eigenvector information or eigenvector information and corresponding eigenvalue information.

Example 20. A method, comprising: receiving, at a network entity, indication of capability from a user equipment, wherein the capability comprises one or more supported quantization types for feedback of channel information by the user equipment; transmitting configuration to the user equipment, wherein the configuration comprises at least information enabling of machine-learning-empowered compression for the channel information; and receiving by the network entity the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

Example 21. The method according to example 20, wherein the first part has fixed size and format.

Example 22. The method according to any one of examples 20 or 21, wherein the second part has a variable size with a maximum size determined by network configuration.

Example 23. The method according to example 22, wherein the feedback has a fixed payload size, the first part and second part fit within the fixed payload size, and any part of the fixed payload size that is not occupied by the first part and second part is occupied by padding.

Example 24. The method according to any one of examples 20 to 22, wherein the second part has a variable format defined by parameters in the first part to enable the second part to be applicable to multiple different machine learning models for generation of the channel state information, multiple different machine learning models for reconstruction of the channel state information, or machine learning model pairs for generation and reconstruction of the channel state information.

Example 25. The method according to any one of examples 20 to 24, wherein a part of a description of the format for precoding matrix information designed for the machine-learning-enabled compression is indicated separately by the user equipment to the network entity in description comprising an encoder model identification or as assistance information which is associated with a dataset for initial training provided by the user equipment to the network entity.

Example 26. The method according to any one of examples 20 to 25, wherein the format for precoding matrix information is in one of a plurality of pre-defined payload sizes having a maximum number bits for an uplink control information carrying the channel state information.

Example 27. The method according to any one of examples 20 to 26, wherein the second part includes actual quantization output in bit sequence.

Example 28. The method according to any one of examples 20 to 27, wherein the second part, as defined at least in part by parameters in the first part, supports multiple numbers of feature vector elements and word length in case of a supported quantization type of scalar quantization or codebook size in case of a supported quantization type of a vector quantization.

Example 29. The method according to any one of examples 20 to 28, wherein the second part, as defined at least in part by parameters in the first part, supports allocating a different number of bits for different quantization resolutions.

Example 30. The method according to any one of examples 20 to 29, wherein the second part, as defined at least in part by parameters in the first part, supports both scalar quantization and vector quantization schemes as supported quantization types with unified bit sequence encoding methodology.

Example 31. The method according to any one of examples 20 to 30, wherein the second part, as defined at least in part by parameters in the first part, supports embedding of channel eigenvalues without changing overall feedback size of the precoding matrix information.

Example 32. The method according to any one of examples 20 to 31, wherein the first and second parts are located into Channel State Information (CSI) Part 1 in their entirety, are located in CSI Part 2 in their entirety, or the first part is located in a CSI Part 1 and the second part located in CSI Part 2.

Example 33. The method according to any one of examples 20 to 32, wherein the first and second parts correspond to a specific encoder model identification indicated by the user equipment to the network entity, the second part comprises information to be interpreted differently as compared to where the first and second parts correspond to other encoder model identifications or no encoder model identification.

Example 34. The method according to example 33, wherein the second part represents a multi-rank case, instead of being a single rank option, within a framework of a same bit resolution per each element representation, or the second part represents a class-less same resolution, instead of first-class and second-classes, a framework of a multi-rank representation.

Example 35. The method according to example 34, wherein the second part comprises information indicating eigenvector-part information, in which a rank index is greater than one, rather than channel eigenvalues.

Example 36. The method according to any one of examples 20 to 35, wherein the format for precoding matrix information provides parameters, within a self-contained structure for the precoding matrix information, for a supported quantization type of scalar quantization or vector quantization, provides a number of elements in the second part, provides quantization resolution, provides dominant channel eigenvector only reporting or full rank reporting, and provides additional reporting of channel eigenvalues for certain configurations enabling the additional reporting.

Example 37. The method according to any one of examples 20 to 36, wherein the transmitting configuration comprises transmitting one or more of the following: additional machine-learning-based report configuration for feedback of the channel state information; feedback payload size; whether scalar quantization or vector quantization is in use as the one or more supported quantization types; whether single dominant eigenvector reports or multiple eigenvector reports are to be reported for the feedback; for scalar quantization, a number of latent vector elements; or for vector quantization, number of subvectors; or enabling of additional eigenvalue reports.

Example 38. The method according to any one of examples 20 to 37, wherein receiving the feedback further comprises receiving a report encoded to contain the feedback so the second part includes one of eigenvector information or eigenvector information and corresponding eigenvalue information.

Example 39. The method according to any one of examples 20 to 38, further comprising decoding the feedback of the channel information.

Example 40. A computer program, comprising instructions for performing the methods of any of examples 1 to 39, when the computer program is run on an apparatus.

Example 41. The computer program according to example 40, wherein the computer program is a computer program product comprising a computer-readable medium bearing instructions embodied therein for use with the apparatus.

Example 42. The computer program according to example 40, wherein the computer program is directly loadable into an internal memory of the apparatus.

Example 43. An apparatus, comprising means for performing: reporting, at a user equipment, a capability to a network entity, wherein the capability comprises one or more supported quantization types for feedback of channel state information; receiving, at the user equipment, configuration from the network entity, wherein the configuration comprises at least information enabling of machine-learning-enabled compression for the channel state information and corresponds to the one or more supported quantization types; and reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

Example 44. The apparatus according to example 43, wherein the first part has fixed size and format.

Example 45. The apparatus according to any one of examples 43 or 44, wherein the second part has a variable size with a maximum size determined by network configuration.

Example 46. The apparatus according to example 45, wherein the feedback has a fixed payload size, the first part and second part fit within the fixed payload size, and any part of the fixed payload size that is not occupied by the first part and second part is occupied by padding.

Example 47. The apparatus according to any one of examples 43 to 45, wherein the second part has a variable format defined by parameters in the first part to enable the second part to be applicable to multiple different machine learning models for generation of the channel state information, multiple different machine learning models for reconstruction of the channel state information, or machine learning model pairs for generation and reconstruction of the channel state information.

Example 48. The apparatus according to any one of examples 43 to 47, wherein a part of a description of the format for precoding matrix information designed for the machine-learning-enabled compression is indicated separately by the user equipment in description comprising an encoder model identification or as assistance information which is associated with a dataset for initial training provided by the user equipment to the network entity.

Example 49. The apparatus according to any one of examples 43 to 48, wherein the format for precoding matrix information is in one of a plurality of pre-defined payload sizes having a maximum number bits for an uplink control information carrying the channel state information.

Example 50. The apparatus according to any one of examples 43 to 49, wherein the second part includes actual quantization output in bit sequence.

Example 51. The apparatus according to any one of examples 43 to 50, wherein the second part, as defined at least in part by parameters in the first part, supports multiple numbers of feature vector elements and word length in case of a supported quantization type of scalar quantization or codebook size in case of a supported quantization type of a vector quantization.

Example 52. The apparatus according to any one of examples 43 to 51, wherein the second part, as defined at least in part by parameters in the first part, supports allocating a different number of bits for different quantization resolutions.

Example 53. The apparatus according to any one of examples 43 to 52, wherein the second part, as defined at least in part by parameters in the first part, supports both scalar quantization and vector quantization schemes as supported quantization types with unified bit sequence encoding methodology.

Example 54. The apparatus according to any one of examples 43 to 53, wherein the second part, as defined at least in part by parameters in the first part, supports embedding of channel eigenvalues without changing overall feedback size of the precoding matrix information.

Example 55. The apparatus according to any one of examples 43 to 54, wherein the first and second parts are located into Channel State Information (CSI) Part 1 in their entirety, are located in CSI Part 2 in their entirety, or the first part is located in a CSI Part 1 and the second part located in CSI Part 2.

Example 56. The apparatus according to any one of examples 43 to 55, wherein the first and second parts correspond to a specific encoder model identification indicated by the user equipment to the network entity, the second part comprises information to be interpreted differently as compared to where the first and second parts correspond to other encoder model identifications or no encoder model identification.

Example 57. The apparatus according to example 56, wherein the second part represents a multi-rank case, instead of being a single rank option, within a framework of a same bit resolution per each element representation, or the second part represents a class-less same resolution, instead of first-class and second-classes, a framework of a multi-rank representation.

Example 58. The apparatus according to example 56, wherein the second part comprises information indicating eigenvector-part information, in which a rank index is greater than one, rather than channel eigenvalues.

Example 59. The apparatus according to any one of examples 43 to 58, wherein the format for precoding matrix information provides parameters, within a self-contained structure for the precoding matrix information, for a supported quantization type of scalar quantization or vector quantization, provides a number of elements in the second part, provides quantization resolution, provides dominant channel eigenvector only reporting or full rank reporting, and provides additional reporting of channel eigenvalues for certain configurations enabling the additional reporting.

Example 60. The apparatus according to any one of examples 43 to 59, wherein the receiving configuration comprises receiving one or more of the following: additional machine-learning-based report configuration for feedback of the channel state information; feedback payload size; whether scalar quantization or vector quantization is in use as the one or more supported quantization types; whether single dominant eigenvector reports or multiple eigenvector reports are to be reported for the feedback; for scalar quantization, a number of latent vector elements; or for vector quantization, number of subvectors; or enabling of additional eigenvalue reports.

Example 61. The apparatus according to any one of examples 43 to 60, wherein reporting the feedback further comprises encoding a report containing the feedback so the second part includes one of eigenvector information or eigenvector information and corresponding eigenvalue information.

Example 62. An apparatus, comprising means for performing: receiving, at a network entity, indication of capability from a user equipment, wherein the capability comprises one or more supported quantization types for feedback of channel information by the user equipment; transmitting configuration to the user equipment, wherein the configuration comprises at least information enabling of machine-learning-empowered compression for the channel information; and receiving by the network entity the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

Example 63. The apparatus according to example 62, wherein the first part has fixed size and format.

Example 64. The apparatus according to any one of examples 62 or 63, wherein the second part has a variable size with a maximum size determined by network configuration.

Example 65. The apparatus according to example 64, wherein the feedback has a fixed payload size, the first part and second part fit within the fixed payload size, and any part of the fixed payload size that is not occupied by the first part and second part is occupied by padding.

Example 66. The apparatus according to any one of examples 62 to 64, wherein the second part has a variable format defined by parameters in the first part to enable the second part to be applicable to multiple different machine learning models for generation of the channel state information, multiple different machine learning models for reconstruction of the channel state information, or machine learning model pairs for generation and reconstruction of the channel state information.

Example 67. The apparatus according to any one of examples 62 to 66, wherein a part of a description of the format for precoding matrix information designed for the machine-learning-enabled compression is indicated separately by the user equipment to the network entity in description comprising an encoder model identification or as assistance information which is associated with a dataset for initial training provided by the user equipment to the network entity.

Example 68. The apparatus according to any one of examples 62 to 67, wherein the format for precoding matrix information is in one of a plurality of pre-defined payload sizes having a maximum number bits for an uplink control information carrying the channel state information.

Example 69. The apparatus according to any one of examples 62 to 68, wherein the second part includes actual quantization output in bit sequence.

Example 70. The apparatus according to any one of examples 62 to 69, wherein the second part, as defined at least in part by parameters in the first part, supports multiple numbers of feature vector elements and word length in case of a supported quantization type of scalar quantization or codebook size in case of a supported quantization type of a vector quantization.

Example 71. The apparatus according to any one of examples 62 to 70, wherein the second part, as defined at least in part by parameters in the first part, supports allocating a different number of bits for different quantization resolutions.

Example 72. The apparatus according to any one of examples 62 to 71, wherein the second part, as defined at least in part by parameters in the first part, supports both scalar quantization and vector quantization schemes as supported quantization types with unified bit sequence encoding methodology.

Example 73. The apparatus according to any one of examples 62 to 72, wherein the second part, as defined at least in part by parameters in the first part, supports embedding of channel eigenvalues without changing overall feedback size of the precoding matrix information.

Example 74. The apparatus according to any one of examples 62 to 73, wherein the first and second parts are located into Channel State Information (CSI) Part 1 in their entirety, are located in CSI Part 2 in their entirety, or the first part is located in a CSI Part 1 and the second part located in CSI Part 2.

Example 75. The apparatus according to any one of examples 62 to 74, wherein the first and second parts correspond to a specific encoder model identification indicated by the user equipment to the network entity, the second part comprises information to be interpreted differently as compared to where the first and second parts correspond to other encoder model identifications or no encoder model identification.

Example 76. The apparatus according to example 75, wherein the second part represents a multi-rank case, instead of being a single rank option, within a framework of a same bit resolution per each element representation, or the second part represents a class-less same resolution, instead of first-class and second-classes, a framework of a multi-rank representation.

Example 77. The apparatus according to example 76, wherein the second part comprises information indicating eigenvector-part information, in which a rank index is greater than one, rather than channel eigenvalues.

Example 78. The apparatus according to any one of examples 62 to 77, wherein the format for precoding matrix information provides parameters, within a self-contained structure for the precoding matrix information, for a supported quantization type of scalar quantization or vector quantization, provides a number of elements in the second part, provides quantization resolution, provides dominant channel eigenvector only reporting or full rank reporting, and provides additional reporting of channel eigenvalues for certain configurations enabling the additional reporting.

Example 79. The apparatus according to any one of examples 62 to 78, wherein the transmitting configuration comprises transmitting one or more of the following: additional machine-learning-based report configuration for feedback of the channel state information; feedback payload size; whether scalar quantization or vector quantization is in use as the one or more supported quantization types; whether single dominant eigenvector reports or multiple eigenvector reports are to be reported for the feedback; for scalar quantization, a number of latent vector elements; or for vector quantization, number of subvectors; or enabling of additional eigenvalue reports.

Example 80. The apparatus according to any one of examples 62 to 79, wherein receiving the feedback further comprises receiving a report encoded to contain the feedback so the second part includes one of eigenvector information or eigenvector information and corresponding eigenvalue information.

Example 81. The apparatus according to any one of examples 62 to 80, wherein the means are further configured for performing: decoding the feedback of the channel information.

Example 82. The apparatus of any preceding apparatus example, wherein the means comprises: at least one processor; and at least one memory storing instructions that, when executed by at least one processor, cause the performance of the apparatus.

Example 83. An apparatus, comprising: one or more processors; and one or more memories storing instructions that, when executed by the one or more processors, cause the apparatus at least to perform: reporting, at a user equipment, a capability to a network entity, wherein the capability comprises one or more supported quantization types for feedback of channel state information; receiving, at the user equipment, configuration from the network entity, wherein the configuration comprises at least information enabling of machine-learning-enabled compression for the channel state information and corresponds to the one or more supported quantization types; and reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

Example 84. An apparatus, comprising: one or more processors; and one or more memories storing instructions that, when executed by the one or more processors, cause the apparatus at least to perform: receiving, at a network entity, indication of capability from a user equipment, wherein the capability comprises one or more supported quantization types for feedback of channel information by the user equipment; transmitting configuration to the user equipment, wherein the configuration comprises at least information enabling of machine-learning-empowered compression for the channel information; and receiving by the network entity the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1B. A computer-readable medium may comprise a computer-readable storage medium (e.g., memories 125 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
5G fifth generation
AI artificial intelligence
AIML Artificial Intelligence and Machine Learning
AMF access and mobility management function
BBU base band unit
CNN Convolutional Neural Network
CR compression ratio
CSI Channel State Information
CSI-RS Channel State Information Reference Signals
CQI Channel Quality Indicator
CU central unit
DFT discrete Fourier transform
DL
downlink
distributed unit
DU
eNB (or eNodeB) evolved Node B (e.g., an LTE base station)
gNB (or gNodeB) base station for 5G/NR
ID identification
I/F interface
LTE long term evolution
ML machine learning
MMO multiple input, multiple output
MME mobility management entity
MU-MIMO multi-user MIMO
ng or NG next generation
ng-eNB or NG-eNB next generation eNB
NR new radio
N/W or NW network
PMI
Precoding Matrix indicator
radio access network
RAN
Rel
release
Rank Indicator
RI
RLC radio link control
RRH remote radio head
RRC radio resource control
RU radio unit
Rx receiver
SGW
serving gateway
study item
SI
SMF
session management function
single user MIMO
SU-MIMO
SQ scalar quantization or quantizer
SVD Singular Value Decomposition
Tx
transmitter
Uplink Control Information
UCI
UE
user equipment (e.g., a wireless, typically mobile device)
UCI uplink control information
UI user interface
UPF user plane function
VQ vector quantization or quantizer

1-43. (canceled)

44. An apparatus, comprising:
one or more processors; and
one or more memories storing instructions that, when executed by the one or more processors, cause the apparatus at least to:
report a capability to a network entity, wherein the capability comprises one or more supported quantization types for feedback of channel state information;
receive configuration from the network entity, wherein the configuration comprises at least information enabling of machine-learning-enabled compression for the channel state information and corresponds to the one or more supported quantization types; and
report the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.

45. The apparatus according to claim 44, wherein the first part has fixed size and format.

46. The apparatus according to claim 44, wherein the second part has a variable size with a maximum size determined by network configuration.

47. The apparatus according to claim 44, wherein the feedback has a fixed payload size, the first part and second part fit within the fixed payload size, and any part of the fixed payload size that is not occupied by the first part and second part is occupied by padding.

48. The apparatus according to claim 44, wherein the second part has a variable format defined by parameters in the first part to enable the second part to be applicable to multiple different machine learning models for generation of the channel state information, multiple different machine learning models for reconstruction of the channel state information, or machine learning model pairs for generation and reconstruction of the channel state information.

49. The apparatus according to claim 44, wherein a part of a description of the format for precoding matrix information designed for the machine-learning-enabled compression is indicated separately by the user equipment in description comprising an encoder model identification or as assistance information which is associated with a dataset for initial training provided by the user equipment to the network entity.

50. The apparatus according to claim 44, wherein the format for precoding matrix information is in one of a plurality of pre-defined payload sizes having a maximum number bits for an uplink control information carrying the channel state information.

51. The apparatus according to claim 44, wherein the second part includes actual quantization output in bit sequence.

52. The apparatus according to claim 44, wherein the second part, as defined at least in part by parameters in the first part, supports multiple numbers of feature vector elements and word length in case of a supported quantization type of scalar quantization or codebook size in case of a supported quantization type of a vector quantization.

53. The apparatus according to claim 44, wherein the second part, as defined at least in part by parameters in the first part, supports allocating a different number of bits for different quantization resolutions.

54. The apparatus according to claim 44, wherein the second part, as defined at least in part by parameters in the first part, supports both scalar quantization and vector quantization schemes as supported quantization types with unified bit sequence encoding methodology.

55. The apparatus according to claim 44, wherein the second part, as defined at least in part by parameters in the first part, supports embedding of channel eigenvalues without changing overall feedback size of the precoding matrix information.

56. The apparatus according to claim 44, wherein the first and second parts are located into Channel State Information (CSI) Part 1 in their entirety, are located in CSI Part 2 in their entirety, or the first part is located in a CSI Part 1 and the second part located in CSI Part 2.

57. The apparatus according to claim 44, wherein the first and second parts correspond to a specific encoder model identification indicated by the apparatus to the network entity, the second part comprises information to be interpreted differently as compared to where the first and second parts correspond to other encoder model identifications or no encoder model identification.

58. The apparatus according to claim 57, wherein the second part represents a multi-rank case, instead of being a single rank option, within a framework of a same bit resolution per each element representation, or the second part represents a class-less same resolution, instead of first-class and second-classes, a framework of a multi-rank representation.

59. The apparatus according to claim 57, wherein the second part comprises information indicating eigenvector-part information, in which a rank index is greater than one, rather than channel eigenvalues.

60. The apparatus according to claim 44, wherein the format for precoding matrix information provides parameters, within a self-contained structure for the precoding matrix information, for a supported quantization type of scalar quantization or vector quantization, provides a number of elements in the second part, provides quantization resolution, provides dominant channel eigenvector only reporting or full rank reporting, and provides additional reporting of channel eigenvalues for certain configurations enabling the additional reporting.

61. The apparatus according to claim 44, wherein the receiving configuration comprises receiving one or more of the following: additional machine-learning-based report configuration for feedback of the channel state information; feedback payload size; whether scalar quantization or vector quantization is in use as the one or more supported quantization types; whether single dominant eigenvector reports or multiple eigenvector reports are to be reported for the feedback; for scalar quantization, a number of latent vector elements; or for vector quantization, number of subvectors; or enabling of additional eigenvalue reports.

62. An apparatus, comprising:
one or more processors; and
one or more memories storing instructions that, when executed by the one or more processors, cause the apparatus at least to perform:
receive indication of capability from a user equipment, wherein the capability comprises one or more supported quantization types for feedback of channel information by the user equipment;
transmit configuration to the user equipment, wherein the configuration comprises at least information enabling of machine-learning-empowered compression for the channel information; and
receive the feedback of the channel information from the user equipment, wherein the feedback uses a format for precoding matrix information designed for the machine-learning-empowered compression, wherein the feedback comprises a first part and a second part, wherein the first part includes partial or full description of a format of the second part and information indicating size of the second part.

63. A method, comprising:
reporting, by a user equipment, a capability to a network entity, wherein the capability comprises one or more supported quantization types for feedback of channel state information;
receiving, at the user equipment, configuration from the network entity, wherein the configuration comprises at least information enabling of machine-learning-enabled compression for the channel state information and corresponds to the one or more supported quantization types; and
reporting by the user equipment the feedback of the channel state information to the network entity, wherein the feedback uses a format for precoding matrix information designed for the machine-learning-enabled compression, wherein the feedback comprises a first part and a second part, wherein the first part includes partial or full description of a format of the second part and information indicating size of the second part.
